(19) United States
(12) Patent Application Publication
(10) Pub. No.: US 2026/0111007 A1
(43) Pub. Date: Apr. 23, 2026

(54) SYSTEMS, APPARATUSES, METHODS, AND COMPUTER PROGRAM PRODUCTS FOR PWO ASSET OPTIMIZATION IN A MULTI-LAYERED ENTERPRISE SYSTEM

(71) Applicant: Honeywell International Inc., Charlotte, NC (US)

(72) Inventors: Rajeeva Naduthota Manjunatha, Bangalore (IN); Ranjeet Das, Bangalore (IN); Shivanky Jaiswal, Bangalore (IN); Sriram Hallihole, Bengaluru (IN); Sumit Raj, Bangalore (IN)

(21) Appl. No.: 18/920,147

(22) Filed: Oct. 18, 2024

(51) Int. Cl. G05B 19/418

(52) U.S. Cl. CPC G05B 19/41835; G05B 2219/37591

(57) ABSTRACT

Embodiments of the present disclosure relate improved asset performance monitoring and plantwide optimization improvement. Performance data for a set of assets may be generated by performing analytics on plant data associated with the set of assets. The set of assets may include at least a plantwide optimizer (PWO) controller and one or more advanced process control (APC) controllers associated with the PWO controller. A first performance metric for the PWO controller that fails to satisfy a first performance threshold may be identified by comparing the performance data to one or more PWO performance thresholds. Performance insight data may be generated in response to identifying the first performance metric at least in part by applying the performance data to one or more analytical models comprising one more asset performance dependency graphs. Performance of one or more plantwide optimization implementation actions may be initiated based on the performance insight data.

### TECHNICAL FIELD

The present disclosure relates, generally, to monitoring assets in a multi-layered enterprise system. Example embodiments provide systems, apparatuses, methods, and computer program products for monitoring and optimizing plantwide optimizer (PWO) in a multi-layered enterprise system.

### BACKGROUND

In various contexts, processing facilities are often managed using process control and automation systems. Many process control and automation systems include multiple hierarchical layers that, individually and/or collectively, include a large number of assets that require continuous monitoring to ensure maximum performance. Applicant has discovered problems with current implementations of monitoring assets in process control and automation systems, including PWO assets. Through applied effort, ingenuity, and innovation, Applicant has solved many of these identified problems by developing solutions embodied in the present disclosure, which are described in detail below.

### BRIEF SUMMARY

In accordance with one aspect of the present disclosure, a computer-implemented method is provided. The computer-implemented method is executable utilizing any of a myriad of computing device(s) and/or combinations of hardware, software, and/or firmware. In some example embodiments, an example computer-implemented method comprises generating, by one or more processors, performance data for a set of assets by performing analytics on plant data associated with the set of assets, wherein the set of assets include at least a plantwide optimizer (PWO) controller and one or more advanced process control (APC) controllers associated with the PWO controller; identifying, by the one or more processors, a first performance metric for the PWO controller that fails to satisfy a first performance threshold by comparing the performance data to one or more PWO performance thresholds; generating, by the one or more processors, performance insight data in response to identifying the first performance metric at least in part by applying the performance data to one or more analytical models comprising one or more asset performance dependency graphs; and initiating, by the one or more processors, performance of one or more plantwide optimization implementation actions based on the performance insight data.

In some embodiments, the computer-implemented method further comprises receiving the plant data from an industrial plant, wherein the plant data comprises PWO data for the PWO controller and APC data for the one or more APC controllers, and wherein the plant data is generated via a process control and monitoring system associated with the industrial plant.

In some embodiments, the computer-implemented comprises generating the one or more analytical models by identifying asset performance dependency relationships between performance metrics for the PWO controller and the one or more APC controllers based on historical asset performance data; and generating the one or more asset performance dependency graphs based on the asset performance dependency relationships.

In some embodiments, the performance insight data comprises one or more items of data representing low performance contributing assets from the set of assets impacting the first performance metric for the PWO controller.

In some embodiments, the one or more analytical models is configured to perform predictive data analysis task on the performance data to identify the low performance contributing assets at least in part by traversing a first performance dependency graph corresponding to the first performance metric.

In some embodiments, the computer-implemented method further comprises identifying a second performance metric for an APC controller of the one or more APC controllers that fails to satisfy a second performance threshold by comparing the performance data to one or more APC performance thresholds; and in response to identifying the second performance metric, applying the performance data to the one or more analytical models configured to perform predictive data analysis task on the performance data using the one or more asset performance dependency graphs.

In some embodiments, the computer-implemented method further comprises determining one or more corrective actions for improving the first performance metric based on the performance insight data.

In some embodiments, initiating the performance of one or more plantwide optimization implementation actions comprises causing rendering of an asset monitoring user interface comprising one or more representations of the performance insight data.

In some embodiments, initiating performance of one or more plantwide optimization implementation actions comprises automatically adjusting one or more parameters associated with a low performance contribution asset.

In some embodiments, the PWO controller is associated with one or more processing units and initiating the performance of one or more plantwide optimization implementation actions comprises automatically adjusting one or more parameters associated with the one or more processing units, wherein the one or more processing units comprise one or more equipment.

In accordance with another aspect of the present disclosure, an apparatus is provided. In some embodiments, the apparatus comprises at least one processor and at least one memory storing instructions that, when executed by the at least one processor, cause the apparatus to generate performance data for a set of assets by performing analytics on plant data associated with the set of assets, wherein the set of assets include at least a plantwide optimizer (PWO) controller and one or more advanced process control (APC) controllers associated with the PWO controller; identify a first performance metric for the PWO controller that fails to satisfy a first performance threshold by comparing the performance data to one or more PWO performance thresholds; generate performance insight data in response to identifying the first performance metric at least in part by applying the performance data to one or more analytical models comprising one or more asset performance dependency graphs; and initiating performance of one or more plantwide optimization implementation actions based on the performance insight data.

In some embodiments, the apparatus is further caused to receive the plant data from an industrial plant, wherein the plant data comprises PWO data for the PWO controller and APC data for the one or more APC controllers, and wherein the plant data is generated via a process control and monitoring system associated with the industrial plant.

In some embodiments, the apparatus is further caused to generate the one or more analytical models by identifying asset performance dependency relationships between performance metrics for the PWO controller and the one or more APC controllers based on historical asset performance data; and generating the one or more asset performance dependency graphs based on the asset performance dependency relationships.

In some embodiments, the performance insight data comprises one or more items of data representing low performance contributing assets from the set of assets impacting the first performance metric for the PWO controller.

In some embodiments, the one or more analytical models is configured to perform predictive data analysis task on the performance data to identify the low performance contributing assets at least in part by traversing a first performance dependency graph corresponding to the first performance metric.

In some embodiments, the apparatus is further caused to identify a second performance metric for an APC controller of the one or more APC controllers that fails to satisfy a second performance threshold by comparing the performance data to one or more APC performance thresholds; and in response to identifying the second performance metric, applying the performance data to the one or more analytical models configured to perform predictive data analysis task on the performance data using the one or more asset performance dependency graphs.

In some embodiments, the apparatus is further caused to determine one or more corrective actions for improving the first performance metric based on the performance insight data.

In some embodiments, initiating the performance of one or more plantwide optimization implementation actions comprises causing rendering of an asset monitoring user interface comprising one or more representations of the performance insight data.

In some embodiments, initiating the performance of one or more plantwide optimization implementation actions comprises automatically adjusting one or more parameters associated with a low performance contribution asset.

In accordance with another aspect of the present disclosure, a computer program product is provided. In some embodiments, the computer program product includes at least one non-transitory computer-readable storage medium having computer coded instructions configured to, when executed by at least one processor generate performance data for a set of assets by performing analytics on plant data associated with the set of assets, wherein the set of assets include at least a plantwide optimizer (PWO) controller and one or more advanced process control (APC) controllers associated with the PWO controller; identify a first performance metric for the PWO controller that fails to satisfy a first performance threshold by comparing the performance data to one or more PWO performance thresholds; generate performance insight data in response to identifying the first performance metric at least in part by applying the performance data to one or more analytical models comprising one or more asset performance dependency graphs; and initiate performance of one or more plantwide optimization implementation actions based on the performance insight data.

### BRIEF DESCRIPTION OF THE SEVERAL VIEWS OF THE DRAWINGS

Having thus described the embodiments of the disclosure in general terms, reference now will be made to the accompanying drawings, which are not necessarily drawn to scale, and wherein:

FIG. 1A illustrates a block diagram of an example system architecture in which embodiments of the present disclosure may operate.

FIG. 1B illustrates a block diagram of an example process control and automation system in accordance with at least one example embodiment of the present disclosure.

FIGS. 1C-1G illustrates example asset performance dependency graphs in accordance with at least one example embodiment of the present disclosure.

FIG. 2 illustrates a block diagram of an example apparatus in accordance with at least one example embodiment of the present disclosure.

FIG. 3 illustrates a data flow diagram showing example data structures for improved asset performance monitoring in accordance with at least one example embodiment of the present disclosure.

FIGS. 4A-4D illustrate example user interfaces in accordance with at least one example embodiment of the present disclosure.

FIG. 5 illustrates flowchart including operations of an example process for asset performance monitoring and optimization in accordance with at least one example embodiment of the present disclosure.

### DETAILED DESCRIPTION

Various embodiments of the present disclosure now will be described more fully hereinafter with reference to the accompanying drawings, in which some, but not all, embodiments of the present disclosure are shown. Indeed, the present disclosure may be embodied in many different forms and should not be construed as limited to the embodiments set forth herein, rather, these embodiments are provided so that this disclosure will satisfy applicable legal requirements.

The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not indicate being based only on or based solely on the referenced element or elements unless so indicated. Like numbers refer to like elements throughout.

### Overview and Technical Improvements

Various embodiments of the present disclosure are generally directed to systems, apparatuses, methods, and computer program products for monitoring assets associated with a process control and automation system, including plantwide optimizer (PWO) assets. Example embodiments disclosed herein address technical challenges associated with monitoring and optimizing PWO assets.

Various layers of assets associated with process control and automation systems necessitate continuous surveillance to maintain optimal performance. For instance, at the regulatory layer, there is a need for monitoring PID controllers (referred to interchangeably herein as PID assets) and instruments, and at the advanced control layer there is a need for monitoring APC controllers (referred to interchangeably herein as APC assets) and PWO controllers (referred to interchangeably herein as PWO assets) to identify issues, implement corrective actions to resolve identified issues, and/or the like. For example, in the advanced control layer, along with unit-level APC controllers (also referred to as secondary APC controllers), PWO controller also need to be monitored to identify poorly performing assets and corrective actions implemented to resolve (e.g., fix) such identified poorly performing assets, as such poorly performing assets may result in safety issues, reduced productivity, and high impact cost, to name a few.

Often, the volume of assets that require monitoring (e.g., real-time or near real-time monitoring) in process control and automation systems is substantial. In a typical site, the regulatory layer alone may include 2500 to 3000 assets that require monitoring, the APC layer may include 10 to 15 model predictive control (MPC) assets comprising over 300 variables that require monitoring, these assets are intricately interconnected such that an issues associated with one layer may affect other assets. For instance, PWO assets at the APC layer may interface with unit-level APC controllers which are connected to instruments (e.g., sensors, control valves, and/or the like) at the regulatory layer. Consequently, any malfunction or issue at the regulatory layer may reverberate through to the unit-level APC controllers and subsequently affect PWO controller functionality. In particular, in many control, an issue that occurs at the regulatory layer tends to impact the unit-level APC controllers and the PWO controller. In this regard, in various examples, the root cause of underperforming PWO controller may originate from other asset layers issues at the regulatory layer, such as, for example, poorly performing controlled variable (CV) in the secondary APC controller poorly performing control valves at the regulatory layer, inadequately tuned PID controllers, and/or the like.

In this regard, it there is a need to accurately diagnose the root cause of poorly performing assets, determine actionable insights for resolving diagnosed issues, and cause implementation of corrective actions to resolve diagnosed issues to ensure optimal functioning and effective maintenance of control assets. Given the impracticality of manually monitoring each asset and the error associated with manual monitoring, there is a need for a consolidated view of poorly performing assets along with recommended actions to, for example, enable prioritizing (e.g., by a user) attention towards critical assets that are pivotal for the process(es) being controlled by the assets and determining actionable insights to enable users to resolve issues promptly so as to ensure effective maintenance of these assets.

In this regard, it is generally difficult to identify and/or resolve issues with a large number of assets. As an example, it is generally desirable for users such as process operators, planning personnel, management personnel, and/or the like to be provided with an understanding of which assets to focus on. Additionally, it is generally desirable for management personnel to be provided with improved technology to facilitate optimal maintenance of assets. For example, conventional user interface technology generally involves manual configuration of the user interface to, for example, provide different insights for assets.

Thus, to address these and/or other issues, asset performance visualization for a set of assets is provided. In example embodiments, the asset performance visualization is provided via a user interface configured for rendering on client computing devices. In example embodiments, processed asset data personalized for a user is presented via the asset management user interface. In example embodiments, the asset performance visualization facilitates digitized maintenance for the set of assets, predictive maintenance for the set of assets, optimization for the set of assets, centralized control for the set of assets, and/or other performance management for set of assets. Example embodiments present insights (e.g., critical issues, critical assets that require attention, and/or the like) related to the set of assets, optimal solution to resolve identified issues related to the set of assets, enhance adherence to performance metrics for the assets, and/or improved efficiency related to workflow for the assets. Additionally, the asset performance visualization provides for improved performance of assets, improved operational efficiency of assets, reduced maintenance time related to assets, and/or improved response time for issues related to the assets.

### Definitions

Many modifications and other embodiments of the disclosure set forth herein will come to mind to one skilled in the art to which this disclosure pertains having the benefit of the teachings presented in the foregoing description and the associated drawings. Therefore, it is to be understood that the embodiments are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

As used herein, the terms “data,” “content,” “digital content,” “information,” and similar terms may be used interchangeably to refer to data capable of being transmitted, received, and/or stored in accordance with embodiments of the present disclosure. Further, where a computing entity is described herein to receive data from another computing entity, it will be appreciated that the data may be received directly from another computing entity or may be received indirectly via one or more intermediary computing entities, such as, for example, one or more servers, relays, routers, network access points, base stations, hosts, and/or the like, sometimes referred to herein as a “network.” Similarly, where a computing entity is described herein to send data to another computing device, it will be appreciated that the data may be sent directly to another computing entity or may be sent indirectly via one or more intermediary computing devices, such as, for example, one or more servers, relays, routers, network access points, base stations, hosts, and/or the like.

### Example Systems and Apparatuses of the Disclosure

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

A non-volatile computer-readable storage medium may include a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

A volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

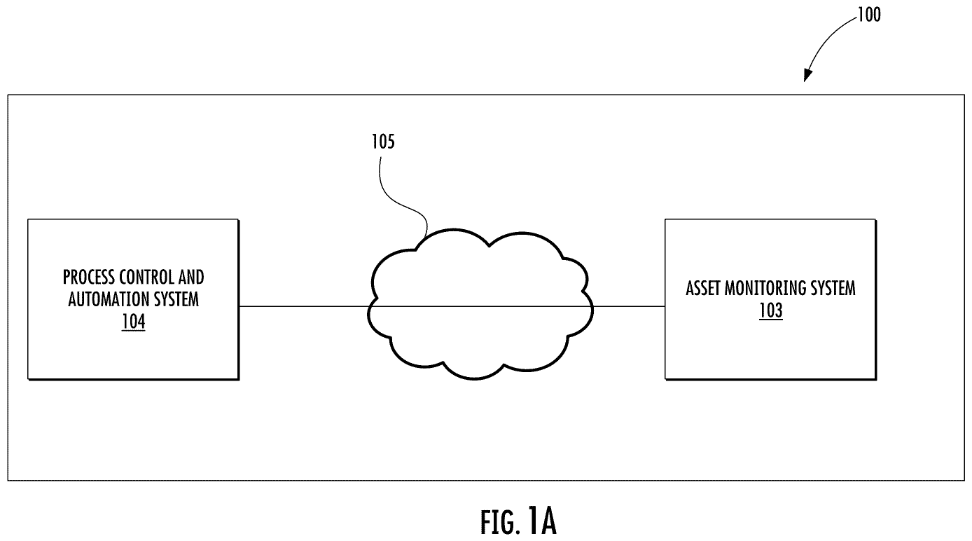

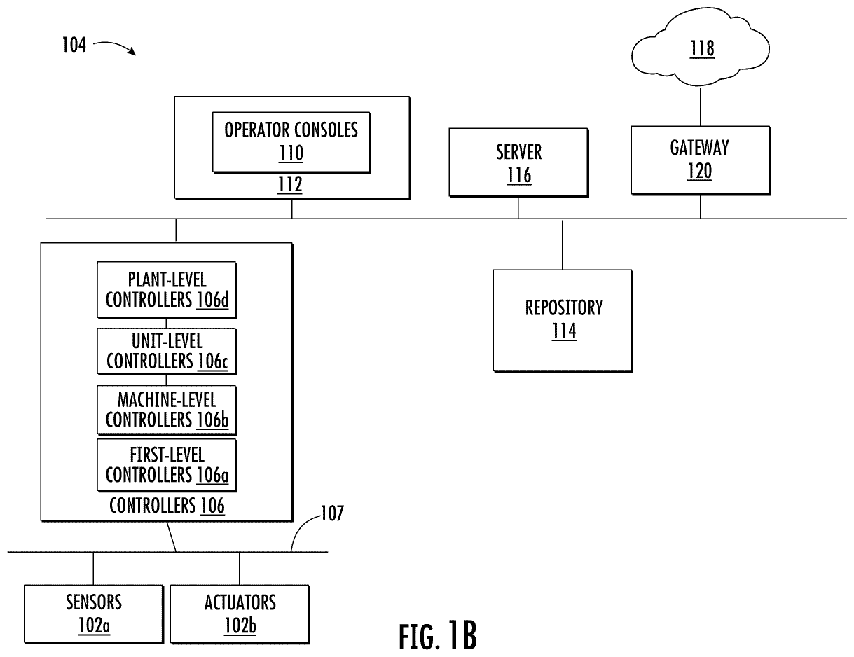

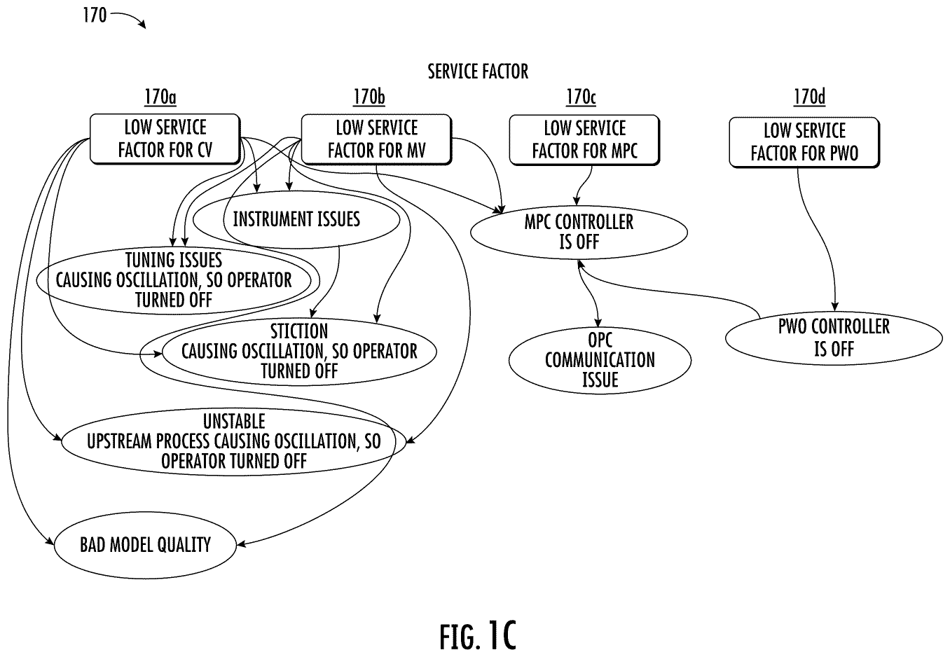

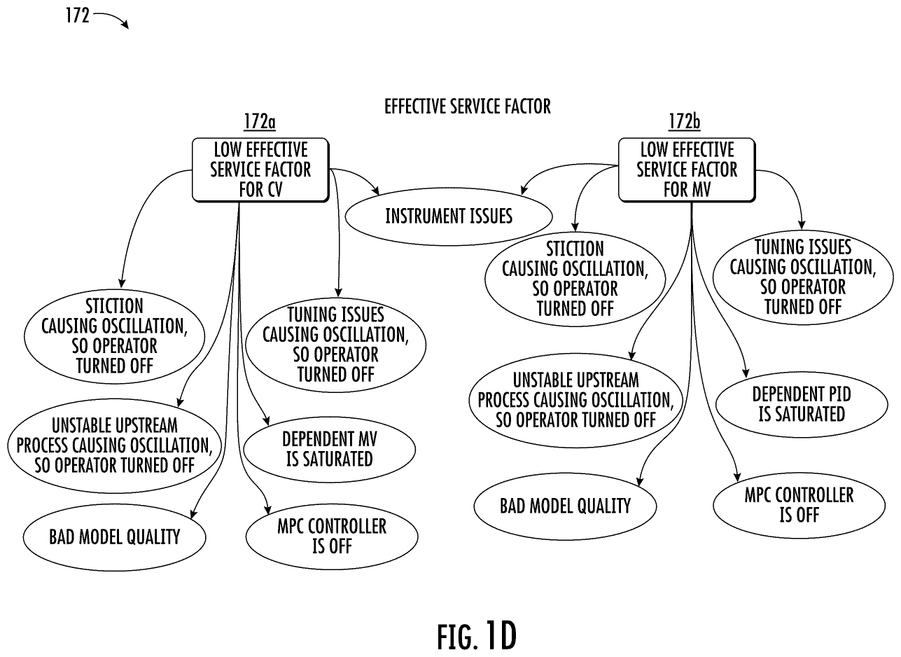

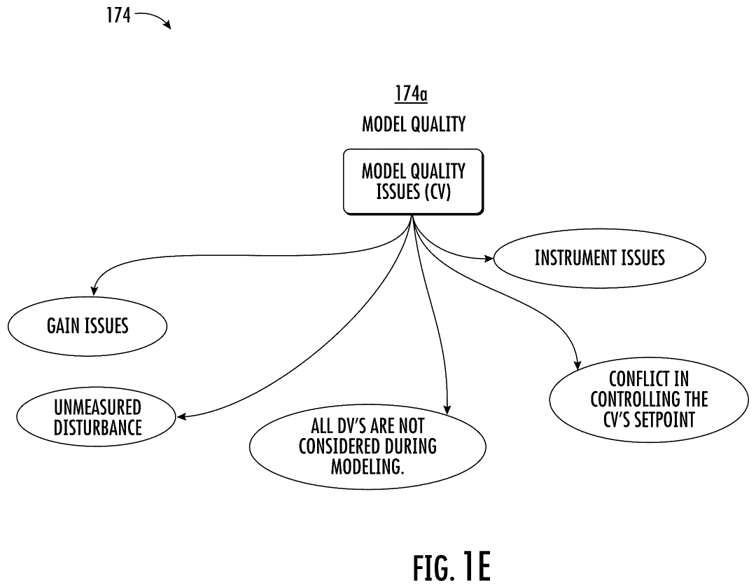

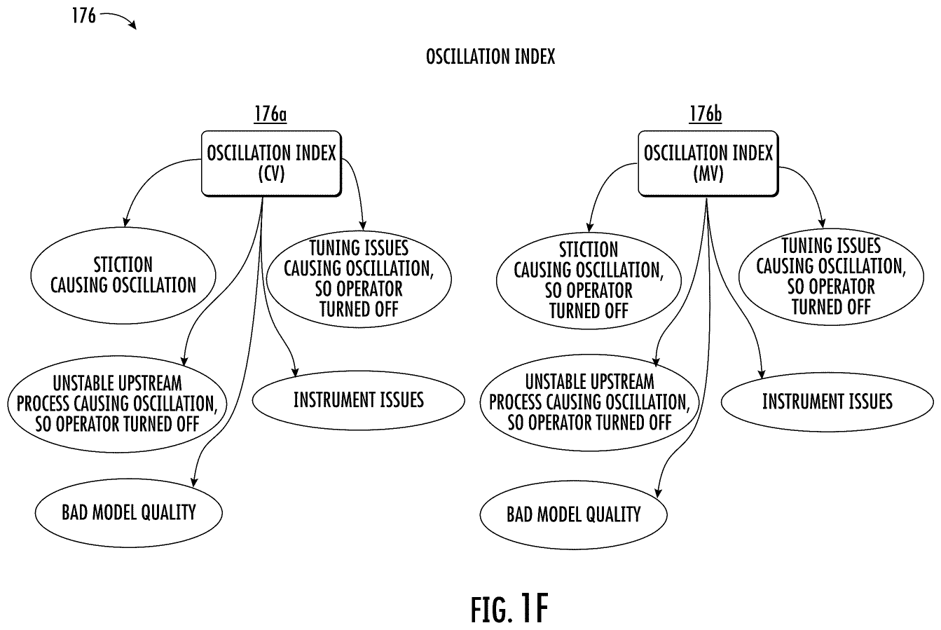

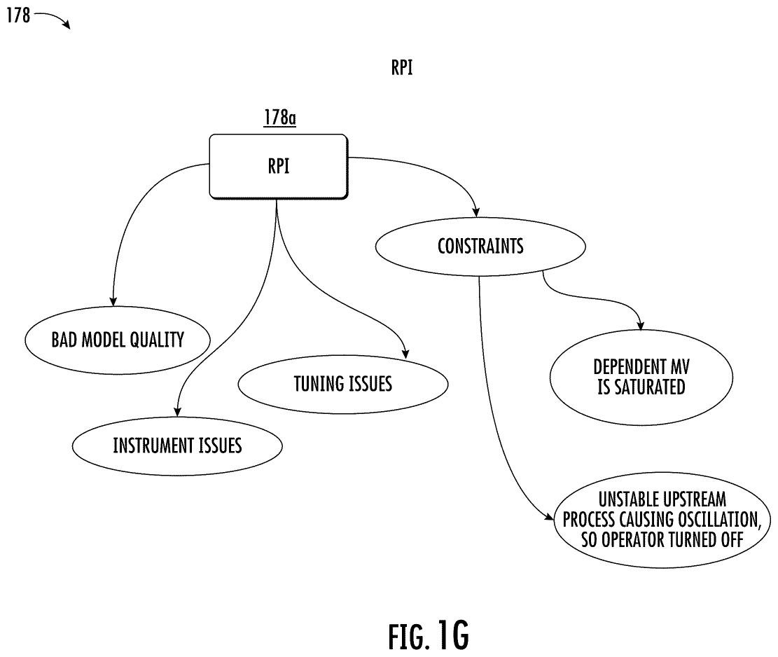

In this regard, FIG. 1A provides an example overview of a system architecture 100 in accordance with at least some example embodiments of the present disclosure. The depiction of the example architecture 100 is not intended to limit or otherwise confine the embodiments described and contemplated herein to any particular configuration of elements or systems, nor is it intended to exclude any alternative configurations or systems for the set of configurations and systems that can be used in connection with embodiments of the present disclosure. Rather, FIG. 1A and the architecture 100 disclosed therein is merely presented to provide an example basis and context for the facilitation of some of the features, aspects, and uses of the methods, apparatuses, computer readable media, and computer program products disclosed and contemplated herein. It will be understood that while many of the aspects and components presented in FIG. 1A are shown as discrete, separate elements, other configurations may be used in connection with the methods, apparatuses, computer readable media, and computer programs described herein, including configurations that combine, omit, separate, and/or add aspects and/or components. The example system architecture 100 may be used in a plurality of domains and not limited to any specific application as disclosed herewith. In particular, while some example embodiments are described herein with reference to industrial plant domain, the example system architecture 100 may be used in a plurality of domains and limited to any specific application as disclosed herein. The plurality of domains may include healthcare, industrial, manufacturing, education, retail, to name a few.

As illustrated, the system architecture 100 includes a process control and automation system 104 in communication with an asset monitoring system 103. In some embodiments, the process control and automation system 104 communicates with the asset monitoring system 103 over one or more communications network(s), for example a communications network 105.

It should be appreciated that the communications network 105 in some embodiments is embodied in any of a myriad of network configurations. In some embodiments, the communications network 105 embodies a public network (e.g., the Internet). In some embodiments, the communications network 105 embodies a private network (e.g., an internal localized, or closed-off network between particular devices). In some other embodiments, the communications network 105 embodies a hybrid network (e.g., a network enabling internal communications between particular connected devices and external communications with other devices). The communications network 105 in some embodiments includes one or more base station(s), relay(s), router(s), switch(es), cell tower(s), communications cable(s) and/or associated routing station(s), and/or the like. In some embodiments, the communications network 105 includes one or more user-controlled computing device(s) (e.g., a user owned router and/or modem) and/or one or more external utility devices (e.g., Internet service provider communication tower(s) and/or other device(s)).

Each of the components of the system architecture 100 may be communicatively coupled to transmit data to and/or receive data from one another over the same or different wireless and/or wired networks embodying the communications network 105. Such configuration(s) include, without limitation, a wired or wireless Personal Area Network (PAN), Local Area Network (LAN), Metropolitan Area Network (MAN), Wide Area Network (WAN), and/or the like. Additionally, while FIG. 1A illustrate certain system entities as separate, standalone entities communicating over the communications network 105, the various embodiments are not limited to this architecture. In other embodiments, one or more computing entities share one or more components, hardware, and/or the like, or otherwise are embodied by a single computing device such that connection(s) between the computing entities are over the communications network 105 are altered and/or rendered unnecessary. For example, in some embodiments, the process control and automation system 104 includes some or all of the asset monitoring system 103, such that an external communications network 105 is not required.

In some embodiments, the process control and automation system 104 is associated with an industrial plant. For example, the industrial plant may implement or otherwise leverage the process control and automation system 104 to control and/or automate one or more processes, equipment, and/or other components of the industrial plant (as further described herein). In some embodiments, the process control and automation system 104 and the asset monitoring system 103 are embodied in an on-premises system within or associated with an industrial plant. In some such embodiments, the process control and automation system 104 and the asset monitoring system 103 may be communicatively coupled via at least one wired connection. Alternatively or additionally, in some embodiments, the process control and automation system 104 embodies or includes the asset monitoring system 103, for example as a software component of a single enterprise terminal. In some embodiments, the asset monitoring system 103 is configured to receive plant data associated with the process control and automation system 104 and perform data analytics on the plant data to generate one or more outputs. For example, the process control and automation system 104 may be configured to generate plant data representative and/or indicative of operational performance, operational, condition, operational status, and/or the like associated with a set of assets as described herein. In various embodiments, the representation of the one or more outputs are provided to client computing devices in accordance with plantwide asset visualization techniques described herein.

The process control and automation system 104 may include any number of computing device(s), system(s), physical component(s), and/or other components. In some embodiments, at least a portion of the process control and automation system 104 includes any number of computing device(s), system(s), physical component(s), and/or the like that facilitates producing of any number of products, for example utilizing particular configurations that cause processing of particular inputs available within the process control and automation system 104. In some embodiments, the process control and automation system 104 includes one or more physical component(s), connection(s) between physical component(s), and/or computing system(s) that control operation of each physical component therein or a portion of the physical components therein. Alternatively or additionally, in some embodiments the process control and automation system 104 includes one or more computing system(s) that are specially configured to operate the physical component(s) in a manner that produces one or more particular product(s) simultaneously.

In some embodiments, process control and automation system 104 includes one or more computing device(s) and/or system(s) embodied in hardware, software, firmware, and/or a combination thereof, that configure and/or otherwise control operation of one or more physical component(s) in the industrial plant. In some embodiments, such computing device(s) and/or system(s) include PWO controller(s), programmable logic controller(s), APC controllers, model predictive control(s) (MPC(s)), application server(s), centralized control system(s), and/or the like, that control(s) configuration and/or operation of at least one physical component. Further, in some embodiments, such computing device(s) and/or systems may be referred to as or otherwise represent a set of assets associated with the process control and automation system 104.

In some embodiments, an asset represents any hardware, software, or other physical or virtual component within a process control and automation system (e.g., such as process control and automation system 104) or an underlying industrial process being controlled via, for example, the process control and automation system. An asset may be associated with a single site (or a portion thereof), multiple sites (or portions thereof), or an enterprise.

In some embodiments, the process control and automation system 104 defines one or more hierarchical layers. In an example embodiment, the hierarchical layer comprises a regulatory layer, advanced process control (APC) layer and/or a plantwide optimizer (PWO) layer. The regulatory layer may comprise one or more instruments (e.g., sensors, actuators, or the like), one or more PID controllers (referred to herein interchangeably as PID assets), and/or other assets. The APC layer may comprise one or more APC controllers (referred to herein interchangeably as APC assets). The PWO layer may comprise one or more PWO controllers (referred to herein interchangeably as PWO assets). In some embodiments, the PWO layer comprises only one PWO controller representing a plantwide optimizer. In some embodiments, the asset monitoring system 103 is configured to monitor at least a portion of the set of assets (e.g., at least a portion of the instruments, PID controller(s), APC controller(s), PWO controller(s), and/or other computing devices and/or systems) embodied by or otherwise associated with process control and automation system 104.

In some embodiments, the hierarchical layers of the process control and automation system 104 may be implemented in any of a variety of architectures and/or models. It will be appreciated that different process control and automation system 104 may include different physical component(s), computing system(s), and/or the like.

FIG. 1B illustrates a block diagram of an example process control and automation system 104 in accordance with at least one example embodiment of the present disclosure. The depiction of the example system 104 is not intended to limit or otherwise confine the embodiments described and contemplated herein to any particular configuration of elements or systems, nor is it intended to exclude any alternative configurations or systems for the set of configurations and systems that can be used in connection with embodiments of the present disclosure. Rather, FIG. 1B disclosed therein is merely presented to provide an example basis and context for the facilitation of some of the features, aspects, and uses of the methods, apparatuses, computer readable media, and computer program products disclosed and contemplated herein. It will be understood that while many of the aspects and components presented in FIG. 1B are shown as discrete, separate elements, other configurations may be used in connection with the methods, apparatuses, computer readable media, and computer programs described herein, including configurations that combine, omit, separate, and/or add aspects and/or components.

As shown in FIG. 1B, the example system 104 includes various components that facilitate production or processing of at least one product or other material. For instance, the process control and automation system 104 may configured for being used to facilitate control over components in one or more industrial plants (e.g., industrial plants such as oil refineries, manufacturing plants, assembling plants, processing plants, and/or the like). Each industrial plant (referred to interchangeably herein as plant, processing plant, or similar terms) may represent one or more sites, such as one or more manufacturing facilities for producing at least one product or other material. In some examples, each industrial plant may implement one or more industrial processes, manufacturing processes, assembling processes, and/or the like and may, individually or collectively, be referred to as a process system. Such industrial processes, manufacturing processes, assembling processes, and/or the like may include and/or otherwise associated with one or more computing devices, systems, physical components (e.g., equipment, machine, and/or the like), A process system may represent any system or portion thereof configured to process one or more products or other materials.

In FIG. 1B, the example process control and automation system 104 may include one or more sensors 102a, one or more actuators 102b, and/or other instruments. The sensors 102a and actuators 102b may represent components in or otherwise associated with a process system (e.g., that may perform any of a wide variety of functions. For example, the sensors 102a may be configured to measure a wide variety of characteristics in the process system, such as flow, pressure, or temperature. In some examples, the actuators 102b may affect or otherwise alter a wide variety of characteristics in the process system, such as, for example, valve openings. In some embodiments, the sensors 102a include any suitable structure for measuring one or more characteristics in a process system. In some embodiments, the actuators 102b include any suitable structure for operating on or affecting one or more conditions in a process system.

At least one network 107 may be coupled to the sensors 102a, actuators 102b, and/or other instruments. The network 107 facilitates interaction with the sensors 102a and actuators 102b. For example, the network 107 may be configured to transport measurement data from the sensors 102a and provide control signals to the actuators 102b. The network 107 may represent any suitable network or combination of networks. In an example embodiment, the communications network 107 includes an ethernet network, electrical signal network, pneumatic control signal network, and/or the like. In some embodiments, the network 107 may include, without limitation, a wired or wireless Personal Area Network (PAN), Local Area Network (LAN), Metropolitan Area Network (MAN), Wide Area Network (WAN), and/or the like. In some embodiments, the network 107 may be substantially similar to the example network 105 described above with reference to FIG. 1A.

The example process control and automation system 104 may include various controllers 106. The controllers 106 may be used in the example process control and automation system 104 to perform various functions in order to control one or more processes of an industrial plant. For example, a first set of controllers 106a may use measurements from one or more sensors 102a to control the operations of one or more actuators 102b. A second set of controllers 106b may be configured and/or used to optimize the control logic or other operations performed by the first set of controllers. A third set of controllers 106c may be configured and/or used to perform additional functions. In some embodiments, the controllers 106 include any suitable structure for controlling one or more aspects of a process/unit or group of processes/units associated with one or more industrial plants. In some embodiments, the controllers 106 may include various types of controllers. For example, in some embodiments, the controllers 106 include proportional-integral-derivative (PID) controllers or multivariable controllers, such as controllers implementing model predictive control (MPC) or other advanced predictive control (APC). For example, in some embodiments, the process control and automation system 104 includes a PWO controller and one or more APC controllers associated with the PWO controller. In some example embodiments, at least one controller represents or comprise a computing device running an operating system.

Operator access to and interaction with the controllers 106 and other components of the system 104 may occur via one or more operator consoles 110. An operator console 110 may comprise computing or communication devices. The operator consoles 110 may be used to provide information to an operator and/or receive information from an operator. For example, the operator console 110 may provide information identifying a current state of one or more processes of an industrial plant to the operator, such as values of various process variables, warnings, alerts, alarms, or other states associated with the industrial process. The operator consoles 110 may also receive information affecting how a process (e.g., industrial process) is controlled, such as by receiving setpoints or control modes for process variables controlled by the controllers 106 or other information that alters or affects how the controllers 106 control the industrial process. The operator consoles 110 may include any suitable structure for displaying information to and interacting with an operator. For example, the operator consoles 110 may represent a computing device running an operating system.

Multiple operator consoles 110 may be grouped together and used in one or more control rooms 112. Each control room 112 may include any number of operator consoles 110 in any suitable arrangement. In some embodiments, multiple control rooms 112 may be used to control an industrial plant, such as when each control room 112 includes operator consoles 110 used to manage a discrete part of the industrial plant.

Each server 116 may comprise a computing device that executes applications for users of the operator consoles 110 or other applications. The applications may be used to support various functions for the operator consoles 110, the controllers 106, or other components of the process control and automation system 104. Each server 116 may represent a computing device running an operating system. It will be appreciated that while shown as being local within the process control and automation system 104, the functionality of the server 116 may be remote from the process control and automation system 104. For instance, the functionality of server 116 may be implemented in a computing cloud 118 or a remote server communicatively coupled to the process control and automation system 104 (e.g., via a gateway 120 or the like).

The process control and automation system 104 may include a repository 114 and/or one or more servers 116. The repository 114 may be configured to stored various information about the process control and automation system 104. The repository 114, for example, may store information that is generated by the various controllers 106 during the control of one or more industrial processes. In some embodiments, the repository 114 includes any suitable structure for storing and facilitating retrieval of information. Although illustrated as a single component in FIG. 1B, the repository 114 may be located elsewhere in the process control and automation system 104, or multiple repositories may be distributed in different locations in the system 104.

In some embodiments, the sensors 102a, actuators 102b, and controllers 106 may be associated with a hierarchical architecture. As described above the hierarchical layers of the process control and automation system 104 may be implemented in any of a variety of architectures and/or models.

By way of non-limiting example, in some embodiments, the process control and automation system 104 may be implemented using an example architecture that includes various levels including “Level 0,” Level 1,” “Level 2,” “Level 3,” and “Level 4” that define, represent, and/or form the layers of the process control and automation system 104.

By way of example, “Level 0” of the example architecture may include one or more sensors 102a and the one or more actuators 102b. In the example architecture, “Level 0” may be associated with the regulatory layer of the process control and automation system 104 or otherwise represent a portion of the components of the regulatory layer of the process control and automation system 104. Further, “Level 0” in the example architecture may include other instruments.

In the example architecture, “Level 1” may include one or more first-level controllers 106a configured to use the measurements from one or more sensors 102a to control the operations of one or more actuators 102b. For example, the one or more first-level controllers 106a may be configured to receive measurement data from one or more sensors 102a and use the measurement data to generate control signals for one or more actuators 102b. The first-level controllers 106a and the one or more sensors 102a and/or one or more actuators may be communicatively coupled via a via communications network such as network 107. “Level 1” may be associated with the regulatory layer of the process control and automation system 104 or otherwise represent a portion of the components of the regulatory layer of the process control and automation system 104.

In the example architecture, “Level 2” may include one or more machine-level controllers 106b. The machine-level controllers 106b may perform various functions to support the operation and control of the first-level controllers 106a, sensors 102a, and actuators 102b, which may be associated with a particular equipment (such as a boiler, machine, or other equipment). For example, the machine-level controllers 106b may be configured to log information collected or generated by the first-level controllers 106a, such as measurement data from the sensors 102a or control signals for the actuators 102b. The machine-level controllers 106b may be configured to execute applications that control the operation of the first-level controllers 106a, thereby controlling the operation of the actuators 102b. Alternatively or additionally, the machine-level controllers 106b may be configured to provide secure access to the controllers 106b. The one or more machine-level controllers 106b may be communicatively coupled to the first-level controllers 106a, the sensors 102a, and/or the actuators 102b. The machine-level controllers 106b may include any suitable structure for providing access to, control of, or operations related to a machine or other equipment. The machine-level controllers 106b may, for example, represent a server computing device running an operating system. Although not shown, different machine-level controllers 106b may be used to control different individual equipment in a process system (where each individual equipment is associated with one or more first-level controllers 106a, sensors 102a, and actuators 102b). In some embodiments, the machine-level controllers 106a include PID controllers. “Level 2” may be associated with the regulatory layer of the process control and automation system 104 or otherwise represent a portion of the components of the regulatory layer of the process control and automation system 104.

In the example architecture, “Level 3” may include one or more unit-level controllers 106c. The unit-level controller 106c may be associated with a process (e.g., process unit) in a process system, where a unit may comprise a collection of one or more machines and/or other equipment (e.g., which could be of various types) operating together to implement at least part of an industrial process. The unit-level controllers 106c may be configured to perform various functions to support the operation and control of components in the lower levels (e.g., Level 1, Level 2, and/or Level 3). For example, the unit-level controllers 106c may log information collected or generated by the components in the lower levels, execute applications that control the components in the lower levels, and provide secure access to the components in the lower levels. The unit-level controllers 106c may include any suitable structure for providing access to, control of, or operations related to one or more machines or other equipment in a process unit. The unit-level controllers 106c may, for example, represent a server computing device running an operating system. Different unit-level controllers 106c may be used to control different units in a process system (where each unit is associated with one or more machine-level controllers 106b, first-level controllers 106a, sensors 102a, and/or actuators 102b). An example of a unit-level controller is an APC controller. “Level 3” may be associated with the advanced process control layer of the process control and automation system 104 or otherwise represent a portion of the components of the advanced process control layer of the process control and automation system 104.

In the example architecture, “Level 4” may include one or more plant-level controllers 106d. The plant-level controllers 106d may be associated with one or more industrial plants, which may include one or more process units that implement the same, similar, or different processes. For example, each plant-level controller may be associated with a particular industrial plant, where the particular industrial plant includes one or more process units. In some examples, an industrial plant is associated with or otherwise represents a particular site. For example, in some embodiments, a site may include a single industrial plant. In some other examples, a site may include more than one industrial plant. The plant-level controllers 106d may be configured to perform various functions to support the operation and control of components in the lower levels. For example, the plant-level controllers 106d may be configured to execute one or more applications such as, but not limited to, scheduling applications, planning applications, plant control applications, process control applications, and/or the like. The plant-level controllers 106d may include any suitable structure for providing access to, control of or operations related to one or more process units in an industrial plant. The plant-level controllers 106d may, for example, represent and/or comprise a server computing device running an operating system. Access to the plant-level controllers 106d may be provided by one or more operator consoles. An example of plant-level controller is a PWO controller. “Level 4” may be associated with the advanced process control layer of the process control and automation system 104 or otherwise represent a portion of the components of the advanced process control layer of the process control and automation system 104.

The example architecture may optionally include one or more additional levels. For example, the example architecture may include an additional level that includes enterprise-level controller(s). The enterprise-level controller(s) may be configured to perform planning operations for multiple sites associated with an enterprise and to control various aspects of the sites. The enterprise-level controller(s) may be configured to perform various functions to support the operation and control of component at the sites. For example, the enterprise-level controller(s) may be configured to execute one or more order processing applications, enterprise resource planning (ERP) applications, advanced planning and scheduling (APS) applications, or any other or additional enterprise control applications. The enterprise-level controllers may include any suitable structure for providing access to, control of, or operations related to control of one or more sites. The enterprise-level controllers may, for example, represent and/or comprises a server computing device running an operating system.

In some embodiments, an enterprise describes an entity (e.g., an organization, corporation, company, or similar terms) having one or more sites (e.g., each comprising one or more industrial plants) to be managed. It would be appreciated that if a single site is to be managed, the functionality of the enterprise-level controller may be incorporated into a plant-level controller 106d. Access to the enterprise-level controller(s) may be provided via one or more operator consoles.

Various levels of the example architecture may include other components, such as one or more repositories. The repository(s) associated with a level may store any suitable information associated with that level or one or more other levels of the process control and automation system 104. A repository may, for example, store information used during production scheduling and optimization.

In some embodiments, the controllers 106 and operator consoles in FIG. 1B may comprise computing devices. For example, each of the controllers 106 (106a-106e) may include one or more processing devices and/or one or more memories for storing instructions and data used, generated, or collected by the processing devices. Each of the controllers 106 may also include at least one network interface, such as one or more Ethernet interfaces or wireless transceivers. Also, each of the operator consoles may include at least one network interface, such as one or more Ethernet interfaces or wireless transceivers.

In some embodiments, one or more component of the process control and automation system 104 may be configured to support the asset monitoring system 103 and/or leverage functionality provided by the asset monitoring system 103. The asset monitoring system 103, for example, may be configured to provide various functionalities including monitoring a set of assets associated with process control and automation system 104 to, for example, ensure optimal performance and/or maintenance of the set of assets. In some embodiments, the set of assets include PWO controllers, APC controllers, and/or other assets. In some embodiments, the APC controllers may comprise MPC controllers.

In some embodiments, proxy limits from a set of assets associated with the process control and automation system 104 (e.g., proxy limits generated based on data from a process control and automation system 104) may be employed to determine an optimization framework for a plantwide optimizer such that all underlying process constraints for the set of assets are considered without creating a large amount of data. Plantwide optimization, including asset monitoring data (e.g., generated by an asset monitoring system such as asset monitoring system 103) may be provided to ensure feasibility of asset optimization and/or to manage asset capability. The process control and automation system 104 may leverage PWO controllers associated therewith along with other controllers (e.g., APC controllers, PID controllers, and/or the like) to provide plantwide optimization using one or more optimization processes to control various operational conditions and/or production inventories, manufacturing activities, or product qualities inside an industrial plant. In some embodiments, plantwide optimization describes optimization or control of multiple units at an industrial plant or site.

In some embodiments, the PWO controller is a primary controller (e.g., a master MPC controller) and the one or more APC controllers comprise or are implemented as multivariable MPC controllers wherein each APC controller is a secondary controller. An APC controller for example may be represented and/or implemented as a multivariable MPC controller comprising one or more control variables (CVs), one or more manipulated variables (MVs) and/or one or more disturbance variables (DVs). As described above, in some embodiments, the PWO controller and the one or more multivariable controllers represent respective computing devices. For example, in some embodiments, the PWO controller and the one or more APC controllers (which may be implemented as multivariable controllers) each include one or more processing devices and one or more memories for storing instructions and data used, generated, or collected by the one or more processing devices. Additionally, in some embodiments, the PWO controller and the one or more APC controllers each include at least one network interface as described above.

In some embodiments, the PWO controller and the one or more APC controllers are configured as a cascaded MPC architecture (such as for example, the example architecture described above) for plantwide control and optimization. For example, to facilitate plantwide optimization as part of the process control and automation functionality of the process control and automation system. In some embodiments, the PWO controller is configured to use a planning model and/or other models. In some embodiments, the PWO controller performs plantwide impact value optimization using one or more optimization processes to control resources, manufacturing activities, or process output qualities at an industrial plant. In some embodiments, the PWO controller is cascaded on top of one or more APC (e.g., one or more multivariable MPC controllers) as described above in the example architecture, wherein each APC controller is configured to provides the PWO controller with respective operating state and/or respective constraints. In this regard, in some embodiments, plantwide optimization provide via a PWO controller accounts for unit-level operating constraints (e.g., APC constraints) from the one or more APCs (e.g., multivariable MPC controllers). In this regard, the PWO controller, the one or more APC controllers, and/or variables (e.g., CV, MV, DV), and/or other components of the various hierarchical levels of the process control and automation system 104 may be interconnected such that the performance of a component may be affected by the performance of or issues with lower level components and/or components in the same level. For example, performance of a PWO controller may be affected by the performance of APC controllers associated with the PWO controller and/or performance of control variables and/or instruments (e.g., sensors, actuators), and/or other controllers in lower levels relative to the PWO controller such in the example architecture describe above.

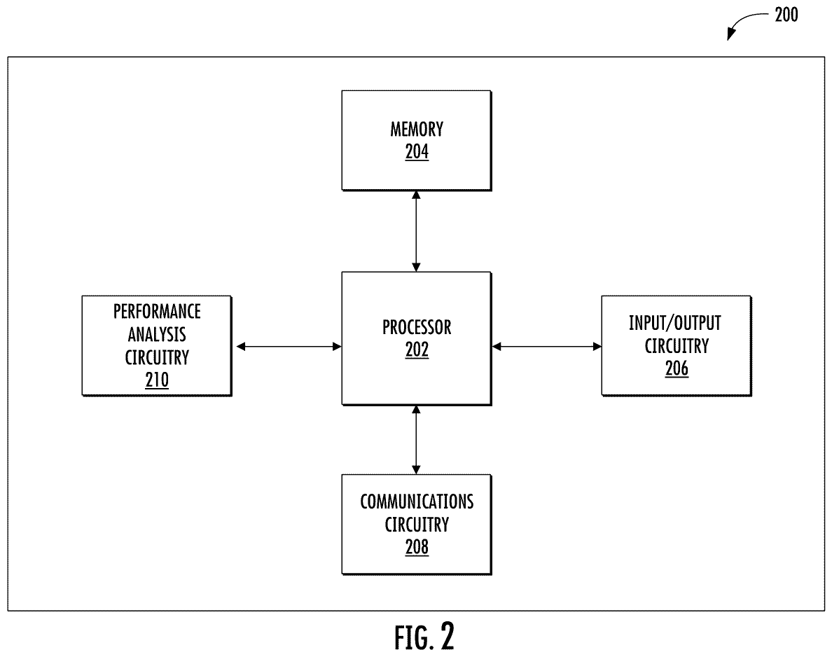

FIG. 2 illustrates a block diagram of an example apparatus that may be specially configured in accordance with at least one example embodiment of the present disclosure. Specifically, FIG. 2 depicts an example asset performance apparatus 200 (“apparatus 200”) specially configured in accordance with at least some example embodiments of the present disclosure. In some embodiments, the asset monitoring system 103 and/or a portion thereof is embodied by one or more system(s), such as the apparatus 200 as depicted and described in FIG. 2. The apparatus 200 includes processor 202, memory 204, input/output circuitry 206, communications circuitry 208, and/or performance analysis circuitry 210. In some embodiments, the apparatus 200 is configured, using one or more of the sets of circuitry embodied by processor 202, memory 204, input/output circuitry 206, communications circuitry 208, and/or performance analysis circuitry 210, to execute and perform the operations described herein.

In general, the terms computing entity (or “entity” in reference other than to a user), device, system, and/or similar words used herein interchangeably may refer to, for example, one or more computers, computing entities, desktop computers, mobile phones, tablets, phablets, notebooks, laptops, distributed systems, items/devices, terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably. In this regard, the apparatus 200 embodies a particular, specially configured computing entity transformed to enable the specific operations described herein and provide the specific advantages associated therewith, as described herein.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), network interface(s), storage medium(s), and/or the like, to perform their associated functions, such that duplicate hardware is not required for each set of circuitry. The use of the term “circuitry” as used herein with respect to components of the apparatuses described herein should therefore be understood to include particular hardware configured to perform the functions associated with the particular circuitry as described herein.

Particularly, the term “circuitry” should be understood broadly to include hardware and, in some embodiments, software for configuring the hardware. For example, in some embodiments, “circuitry” includes processing circuitry, storage media, network interfaces, input/output devices, and/or the like. Alternatively or additionally, in some embodiments, other elements of the apparatus 200 provide or supplement the functionality of another particular set of circuitry. For example, the processor 202 in some embodiments provides processing functionality to any of the sets of circuitry, the memory 204 provides storage functionality to any of the sets of circuitry, the communications circuitry 208 provides network interface functionality to any of the sets of circuitry, and/or the like.

In some embodiments, the processor 202 (and/or co-processor or any other processing circuitry assisting or otherwise associated with the processor) is/are in communication with the memory 204 via a bus for passing information among components of the apparatus 200. In some embodiments, for example, the memory 204 is non-transitory and may include, for example, one or more volatile and/or non-volatile memories. In other words, for example, the memory 204 in some embodiments includes or embodies an electronic storage device (e.g., a computer readable storage medium). In some embodiments, the memory 204 is configured to store information, data, content, applications, instructions, or the like, for enabling the apparatus 200 to carry out various functions in accordance with example embodiments of the present disclosure.

The processor 202 may be embodied in a number of different ways. For example, in some example embodiments, the processor 202 includes one or more processing devices configured to perform independently. Additionally or alternatively, in some embodiments, the processor 202 includes one or more processor(s) configured in tandem via a bus to enable independent execution of instructions, pipelining, and/or multithreading. The use of the terms “processor” and “processing circuitry” should be understood to include a single core processor, a multi-core processor, multiple processors internal to the apparatus 200, and/or one or more remote or “cloud” processor(s) external to the apparatus 200.

In an example embodiment, the processor 202 is configured to execute instructions stored in the memory 204 or otherwise accessible to the processor. Alternatively or additionally, the processor 202 in some embodiments is configured to execute hard-coded functionality. As such, whether configured by hardware or software methods, or by a combination thereof, the processor 202 represents an entity (e.g., physically embodied in circuitry) capable of performing operations according to an embodiment of the present disclosure while configured accordingly. Alternatively or additionally, as another example in some example embodiments, when the processor 202 is embodied as an executor of software instructions, the instructions specifically configure the processor 202 to perform the algorithms embodied in the specific operations described herein when such instructions are executed. As one particular example embodiment, the processor 202 is configured to perform various operations associated with performing improved asset monitoring associated with a process control and automation system.

In some embodiments, the apparatus 200 includes input/output circuitry 206 that provides output to the user and, in some embodiments, to receive an indication of a user input. In some embodiments, the input/output circuitry 206 is in communication with the processor 202 to provide such functionality. The input/output circuitry 206 may comprise one or more user interface(s) and in some embodiments includes a display that comprises the interface(s) rendered as a web user interface, an application user interface, a user device, a backend system, or the like. In some embodiments, the input/output circuitry 206 also includes a keyboard, a mouse, a joystick, a touch screen, touch areas, soft keys a microphone, a speaker, or other input/output mechanisms. The processor 202 and/or input/output circuitry 206 comprising the processor may be configured to control one or more functions of one or more user interface elements through computer program instructions (e.g., software and/or firmware) stored on a memory accessible to the processor (e.g., memory 204, and/or the like). In some embodiments, the input/output circuitry 206 includes or utilizes a user-facing application to provide input/output functionality to a client device and/or other display associated with a user.

In some embodiments, the apparatus 200 includes communications circuitry 208. The communications circuitry 208 includes any means such as a device or circuitry embodied in either hardware or a combination of hardware and software that is configured to receive and/or transmit data from/to a network and/or any other device, circuitry, or module in communication with the apparatus 200. In this regard, in some embodiments the communications circuitry 208 includes, for example, a network interface for enabling communications with a wired or wireless communications network. Additionally or alternatively in some embodiments, the communications circuitry 208 includes one or more network interface card(s), antenna(s), bus(es), switch(es), router(s), modem(s), and supporting hardware, firmware, and/or software, or any other device suitable for enabling communications via one or more communications network(s). Additionally or alternatively, the communications circuitry 208 includes circuitry for interacting with the antenna(s) and/or other hardware or software to cause transmission of signals via the antenna(s) or to handle receipt of signals received via the antenna(s). In some embodiments, the communications circuitry 208 enables transmission to and/or receipt of data from user device, one or more asset(s) or accompanying sensor(s), and/or other external computing device in communication with the apparatus 200.

In some embodiments, the apparatus 200 includes performance analysis circuitry 210. The performance analysis circuitry 210 includes hardware, software, firmware, and/or a combination thereof, that supports asset monitoring, including generating asset performance insights as described herein. For example, in some embodiments, the performance analysis circuitry 210 includes hardware, software, firmware, and/or a combination thereof, configured to, with the processing circuitry 202, input/output circuitry 206 and/or communications circuitry 208, perform one or more functions associated with the asset performance monitoring. In some embodiments, the performance analysis circuitry 210 includes a separate processor, specially configured field programmable gate array (FPGA), or a specially programmed application specific integrated circuit (ASIC).

Alternatively or additionally or in some embodiments, one or more of the sets of circuitries embodying processor 202, memory 204, input/output circuitry 206, communications circuitry 208, and/or performance analysis circuitry 210. perform some or all of the functionality described as associated with another component. For example, in some embodiments, two or more of the sets of circuitry embodied by processor 202, memory 204, input/output circuitry 206, communications circuitry 208, and/or performance analysis circuitry 210, are combined into a single module embodied in hardware, software, firmware, and/or a combination thereof. Similarly, in some embodiments, one or more of the sets of circuitry, for example performance analysis circuitry 210, is/are combined with the processor 202, such that the processor 202 performs one or more of the operations described above with respect to each of these sets of circuitry embodied by the performance analysis circuitry 210.

### Example System Operations

In various embodiments, the asset monitoring system 103 provides or otherwise implements plantwide asset visualization for a process control and automation system 104 and/or user associated with a process control and automation system 104. In some embodiments, the plantwide asset visualization may be configured to reduce the time to identify critical issues and/or asset performance insights related to a set of assts (e.g., set of assets associated with a process control and automation system 104 as described above). In this regard, in various embodiments, the by providing plantwide asset visualization, the asset monitoring system facilitates faster response to issues related to the set of assets and/or improves operational efficiency associated with the set of assets

In various embodiments, the plantwide asset visualization provides for improved productivity and reduced impact value (e.g., reduced cost, and/or the like) related to the set of assets, improved monitoring of the assets, and/or improved efficiency of assets.

In some embodiments, the plantwide asset visualization enables proactive investigation of poorly performing assets to identify issues and resolve such identified issues. In some embodiments, the plantwide asset visualization provides a Integrating a unified and/or consolidated via that enables a user to interact with various data across an enterprise (e.g., various plants, sites, process units, and/or the like) in a single view. In some embodiments, the plantwide asset visualization provides asset performance insights that allows users (which may be located remotely from the set of assets) to understand issues related to the set of assets and/or fault propagation.

In some embodiments, plantwide asset visualization provides a consolidated view of poorly performing assets associated with the set of assets, particularly PWO controller. In some embodiments, the plantwide asset visualization provides recommendations to improve asset performance. In various embodiments, the plantwide asset visualization facilitates and/or causes remote control and/or modification of asset parameters such as, for example set points. In various embodiments, identified, detected and/or predicted issues/faults associated with the set of assets are ranked such that issues with a largest impact with respect to one or more optimization goals are presented via the plantwide asset visualization. Examples of such impact include low performance metric value, resource consumption, and/or the like. In some embodiments, the plantwide asset optimization may provide for a user to access and/or employ the plantwide asset visualization is to identify issues associated with the set of assets, to make adjustment with respect to the set of assets, and/or perform other optimization actions.

In various embodiments, the plantwide asset visualization provides performance metrics (e.g., key performance indicator (KPI)) related to the set of assets. In some embodiments, the plantwide asset visualization generates a notification in response to a determination that a performance metric (e.g., a KPI) for an asset fails to satisfy a corresponding threshold.

In some embodiments, the plantwide asset visualization provides and/or otherwise presents prediction data related to a root cause for one or more issues and/or one or more events related to the set of assets. In some embodiments, the plantwide asset visualization provides asset health information related to the set of assets. In some embodiments, the plantwide asset visualization may be leveraged to implement one or more optimization implementation actions associated with the set of assets. Examples of such actions include modification to asset configuration, and/or other actions.

In this regard, in some embodiments, the plantwide asset visualization provides a unified view or location for users to easily understand operational status of assets, investigate issues related to assets, identify and/or select solution to issues, and/or to make control changes related to assets. In this regard, in some embodiments, the plantwide asset visualization present highest priority issues, poorly performing assets, and/or low performance contributing asset (e.g., assets contributing to low performance of other asset). Additionally, in various embodiments, operating and maintenance impact value, such as for example, operating and maintenance cost, are reduced while also improving equipment up-time, service operational efficiency, and/or environmental conditions by employing the plantwide asset visualization. Additionally, by employing the plantwide asset visualization according to various embodiments, remote triage of faults and/or remote resolution of assets issues is provided.

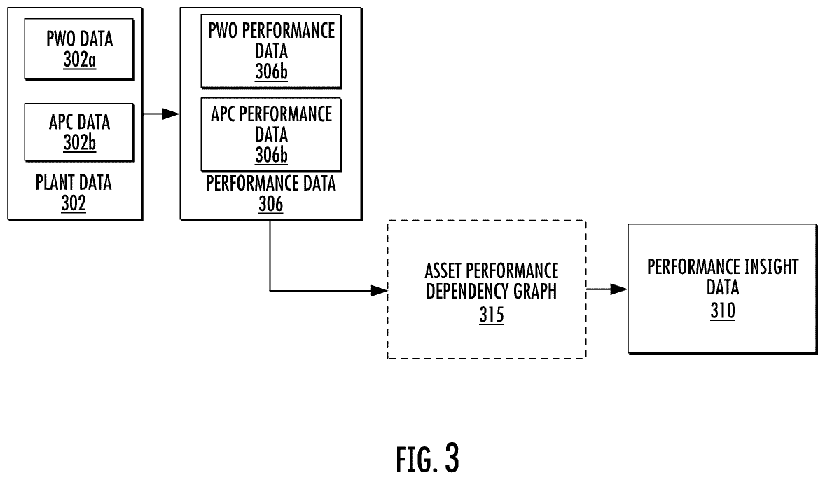

FIG. 3 is a data flow diagram showing example data structures for improved asset performance monitoring in accordance with at least one example embodiment of the present disclosure. In various embodiments, the asset monitoring system 103 is configured to receive plant data comprising data associated with a set of asset associated with the process control and automation system 104, perform predictive analysis based on the received plant data to identify poorly performing assets, and initiate performance of one or more asset improvement implementation actions.

In some embodiments, asset monitoring system 103 is configured to receive plant data 302 associated with an industrial plant. The system 103 may receive the plant data 302 from the process control and automation system 104 associated with an industrial plant. In various embodiments, the process control and automation system 104 is implemented or otherwise employed by the industrial plant to control and/or automate one or more processes of the industrial plant.

In various embodiments, the industrial plant is associated with an enterprise system. An enterprise system may be defined at least in part by an enterprise operational hierarchy comprising unit level, plant level, site level, and enterprise level. The unit level may comprise one or more units (e.g., plant equipment/unit configured to output one or more intermediate or finished products). The plant level may comprise one or more industrial plants, where each industrial plant comprises one or more units (e.g., plant equipment). The site level may comprise one or more sites, where each site comprises one or more industrial plants. The enterprise level, in turn, may comprise one or more sites. In some embodiments, the operational hierarchy may further include an area level above the unit level but below the plant level. In various embodiments, the system may receive plant data 302 for each of one or more industrial plants associated with the enterprise system. In this regard, the enterprise system may be referred to herein as a multi-layered enterprise system.

In various embodiments, at least a portion of the plant data 302 comprise PWO data 302a for a PWO controller associated with the industrial plant. Additionally, in various embodiments, at least a portion of the plant data 302 comprise APC data 302b for one or more APC controllers associated with the PWO controller. In various embodiments, the PWO controller and one or more APC controllers represent components of, or otherwise associated with, a process control and automation system 104 associated with the industrial plant.

In various embodiments, the asset monitoring system 103 is configured to generate performance data 306 based on the plant data 302. In various embodiments, the performance data 306 comprises PWO performance data 306a for the PWO controller and/or APC performance data 306b for the one or more APC controllers. In various embodiments, the PWO performance data 306a comprises one or more items of data representative and/or descriptive of the performance of the PWO with respect to one or more performance metrics for the PWO. For example, the PWO performance data 306a may comprise calculated and/or predicted values for one or more KPIs for the PWO controller and/or one or more variables associated with the PWO controller. For example, the PWO performance data 306a may comprise calculated and/or predictive values for one or more control variables (CVs), one or more manipulated variables (MVs), one or more disturbance variables (DV), and/or other variables associated with the PWO controller.

In various embodiments, the APC performance data 306b comprises one or more items of data representative and/or descriptive of the performance of at least one APC controller with respect to one or more performance metrics for the APC. For example, the APC performance data 306b may comprise calculated and/or predicted values for one or more KPIs for at least one APC controller and/or one or more variables associated with the respective APC controller. For example, the APC performance data 306b may comprise calculated and/or predictive values for one or more control variables (CVs), one or more manipulated variables (MVs), one or more disturbance variables (DV), and/or other variables associated with the APC controller.

In various embodiments, the PWO performance data 306a for the PWO controller may be generated based on the calculated and/or predicted values for the one or more APC controllers associated with the PWO controller. Alternatively or additionally, in various embodiments, the APC performance data 306b for an APC controller may be generated based on the calculated and/or predicted values for one or more variables (CV, MV, DV, or the like) associated with the APC controller.

Non-limiting examples of KPIs for assets such as PWO controllers and APC controllers and associated variables include service factor (SF), model quality index (MQI), Inferential quality index (IQI), RPI, stiction, percent saturation, oscillation index, effective service factor (ESF), lost opportunity, benefit, and/or the like. For example, the asset monitoring system 103 may be configured to generate performance data 306 comprising calculated and/or predicted values for service factor (SF), model quality index (MQI), Inferential quality index (IQI), RPI, stiction, percent saturation, oscillation index, effective service factor (ESF), lost opportunity, benefit, and/or other KPIs for a PWO controller; one or more variables (e.g., CV, MV, and/or DV) associated the PWO controller; one or more APC controllers associated with the PWO controller; and/or one or more variables (e.g., CV, MV, and/or DV) associated with a respective APC controller of the one or more APC controllers.

In various embodiments, generating the performance data 306 comprises calculating the PWO performance data 306a and APC performance data 306b based on relevant portions of the plant data 302. For example, in various embodiments, the asset monitoring system 103 is configured to generate the PWO performance data 306a by calculating one or more KPI values for the PWO using the PWO data 302a and generate the APC performance data 306b for one or more APC controllers by calculating the one or more KPI values for the respective APC controller using the APC data 302b. For example, the PWO performance data 306a may comprise one or more KPI values for the PWO controller and the APC performance data 306b may comprise KPI values for one or more APC controllers associated with the PWO controller.

In some embodiments, the asset monitoring system 103 is configured to generate the performance data 306 using one or more specially-configured algorithms. In some embodiments, the asset monitoring system 103 is configured to apply the plant data 302 to one or more performance analysis machine learning model configured to receive the plant data 302 and perform a predictive performance analysis operation on the plant data 302 to generate the performance data 306.

In some embodiments, applying the plant data 302 to the one or more performance analysis machine learning models comprises the asset monitoring system 103 inputting the plant data 302 into the one or more performance analysis machine learning models and obtaining the performance data 306 output by the performance analysis machine learning model, wherein the performance data 306 output by the performance analysis machine learning model comprises the PWO performance data 306a and the APC performance data 306b.

In some embodiments, applying the plant data 302 to the one or more performance analysis machine learning models comprises the asset monitoring system 103 applying the PWO data 302a to the one or more performance analysis machine learning models to perform predictive performance analysis operation on the PWO data 302a to generate the PWO performance data 306a. In such some embodiments, applying the plant data 302 to the one or more performance analysis machine learning models further comprises the asset monitoring system 103 applying the APC data 302b to the one or more performance analysis machine learning models to perform predictive performance analysis operation on the APC data 302b to generate the APC performance data 306b.

In various embodiments, the asset monitoring system 103 is configured to identify performance metrics for the PWO controller that fail to satisfy the corresponding performance threshold for the performance metric based on the performance data for the PWO controller. In various embodiments, a PWO controller identified as having a performance metric that fails to satisfy the corresponding performance threshold may be referred to as a poorly performing PWO at least with respect to the particular performance metric that fails to satisfy the corresponding performance threshold.

Alternatively or additionally, in various embodiments, the asset monitoring system 103 is configured to identify performance metrics for the APC controller(s) that fail to satisfy the corresponding performance threshold for the performance metric based on the performance data for the APC controller(s). In various embodiments, an APC controller identified as having a performance metric that fails to satisfy the corresponding performance threshold may be referred to as a poorly performing APC at least with respect to the particular performance metric that fails to satisfy the corresponding performance threshold.

In various embodiments, the asset monitoring system 103 is configured identify one or more assets of the sets of assets impacting the performance of the PWO controller with respect to a given performance metric (e.g., causing the performance of the PWO controller to fail to satisfy the performance threshold for the given performance metric). Alternatively or additionally, in various embodiments, the asset monitoring system 103 is configured identify one or more assets of the sets of assets impacting the performance of an APC controller with respect to a given performance metric (e.g., causing the performance of the APC controller to fail to satisfy the performance threshold for the given APC controller). For example, the asset monitoring system 103 may configured to identify from the set of assets associated with the process control and automation system 104, a subset of the set of assets impacting the performance of the PWO controller and/or impacting the performance of an APC controller.

In various embodiments, the asset monitoring system 103 leverages one or more analytical models to identify low performance contributing assets in response to determining that an asset such a PWO controller, APC controller, and/or or other assets fail to satisfy the corresponding threshold. For example, in response to determining that a performance metric for a PWO controller fails to satisfy the corresponding threshold, the asset monitoring system 103 identifies low performance contributing assets with respect to the performance metric for the PWO controller. In some embodiments, identifying low performance contributing assets with respect to the performance metric for the PWO controller includes identifying the top N poor performing assets associated with the PWO controller. As another example, in response to determining that a performance metric for an APC controller fails to satisfy the corresponding threshold, the asset monitoring system 103 identifies low performance contributing assets with respect to the performance metric for the APC controller. In some embodiments, identifying low performance contributing assets with respect to a performance metric for the APC includes identifying the top N poor performing assets associated with the PWO controller. As another example, in response to determining that a performance metric for a variable (e.g., CV, MV, DV, or the like) fails to satisfy the corresponding threshold, the asset monitoring system 103 identifies low performance contributing assets with respect to the performance metric for the variable.

In some embodiments, identifying low performance contributing assets with respect to a performance metric for the variable includes identifying the top N poor performing assets associated with the variable with respect to the performance metric. In some embodiments, a poor performing asset may describe an asset that is associated with a performance metric below a corresponding threshold. In some embodiments, N is an integer (e.g., 1, 4, 7, or the like) and may be the same or different for the various assets and/or performance metrics.

In some embodiments, the one or more analytical models may comprise a ranking model and/or algorithm such that the one or more analytical models may be configured to rank identified poor performing assets and select the top N poor performing assets. For example, the one or more analytical models may be configured to rank the APC controllers connected to the PWO controller in descending order based on calculated and/or predicted performance metric values and select the top N APC controllers as the subset of the APC controllers impacting a performance metric associated with the PWO controller (e.g., low performance contributing assets). As another example, the one or more analytical models may be configured to rank control variables associated with an APC controller or PWO controller in descending order based on calculated and/or predicted performance metric values and select the top N APC controllers as the subset of the APC controllers impacting a performance metric associated with the APC controller or PWO controller (e.g., low performance contributing assets).

In some embodiments, the asset monitoring system 103 is configured to apply the performance data 306 to one or more analytical models (e.g., at least one of the one or more analytical models) configured to perform predictive data analysis task on the performance data 306 to generate performance insight data 310 (e.g., asset performance insight data). In some embodiments, the performance insight data 310 includes one or more items of data representative and/or indicative of low performance contributing assets with respect to the PWO controller, APC controller(s), and/or other assets associated with the process control and monitoring system 104. In some embodiments, the performance insight data 310 may comprise at least one or more items of data representing low performance contributing assets (e.g., from the set of assets) impacting a first performance metric for the PWO controller. For example, in some embodiments, the asset monitoring system 103 may be configured to identify a first performance metric for the PWO controller that fails to satisfy a first performance threshold by comparing the performance data to one or more PWO performance thresholds and generate performance insight data in response to identifying the first performance metric at least in part by applying the performance data to one or more analytical models comprising one or more asset performance dependency graphs, wherein performance insight data comprises at least one or more items of data representing low performance contributing assets (e.g., from the set of assets) impacting a first performance metric for the PWO controller. The asset monitoring system 103 may be configured to identify a second performance metric for an APC controller that fails to satisfy a second performance threshold by comparing the second performance data to one or more APC performance thresholds and in response to identifying the second performance metric, apply the second performance data to one or more analytical models configured to perform predictive data analysis task on the performance data using the one or more asset performance dependency graphs to generate performance insight data that includes data representing low performance contributing assets impacting the second performance metric for the APC controller, which in turn, may impact the performance of one or more performance metrics for the PWO controller. In some embodiments, the asset monitoring system 103 may be configured to determine one or more corrective actions for improving a performance metric such as the first performance metric and the second performance metric based on performance insight data 310. The asset monitoring system 103 may be configured to provide the corrective action to a client computing device associated with a user. In some embodiments, the performance insight data 310 may include data representative and/or indicative of the corrective action(s).

In some embodiments, applying the performance data 306 to one or more analytical models comprises inputting, by the asset monitoring system 103, performance data 306 to the one or more analytical models and obtaining the performance insight data 310 output by the one or more analytical models. In some embodiments, the one or more analytical models define or otherwise comprise one or more asset performance dependency graphs 315 that are leveraged by the one or more analytical models to generate performance insight data 310. In this regard, in some embodiments, the one or more analytical models may be configured to perform predictive data analysis task on the performance data 306 using the one or more service performance dependency graphs (or portion thereof). In this regard, in some embodiments, performing predictive data analysis task on the performance data 306 includes traversing the one or more performance dependency graphs (or portion thereof) to identify assets associated with the PWO controller, an APC controller, CV, MV, DV, and/or other assets contributing to the low performance of the respective asset by analyzing the performance data and using the asset performance dependency graphs.

In some embodiments, an asset performance dependency graph is a graphical representation of dependency relationships between and/or among assets with respect to each of one or more performance metrics. The asset performance dependency graph, for example, may represent a fault propagation tree (e.g., root cause propagation tree) associated with a set of assets associated with the process control and automation system 104. In some embodiments, the asset performance dependency graph may take the form of a spider web view.

FIGS. 1C-1G illustrates example asset performance dependency graphs in accordance with at least on example embodiment of the present disclosure. In particular, FIG. 1C illustrates service factor dependency graph 170 in accordance with at least one example embodiment of the present disclosure, FIG. 1D illustrates an effective service factor dependency graph 172 in accordance with at least one example embodiment of the present disclosure, FIG. 1E illustrates a model quality dependency graph 174 in accordance with at least one example embodiment of the present disclosure. FIG. 1F illustrates an oscillation index dependency graph 176 in accordance with at least one example embodiment of the present disclosure, FIG. 1G illustrates an RPI dependency graph 178 (defining a fault propagation tree for RPI performance metric and having a parent node 178a and child nodes) in accordance with at least one example embodiment of the present disclosure.

In some embodiments, the service factor dependency graph 170 defines or otherwise represents a fault propagation tree for service effective factor performance metric for a PWO controller, MPC controller, manipulated variable, and/or control variable. The service factor dependency graph 170 may include a CV low service factor parent node 170a, MV low service factor parent node 170b, MPC low service factor parent node 170c, and/or PWO low service factor parent node 170d. Additionally, the service factor dependency graph may include one or more child nodes for each parent nodes 170a-d which may or may not be interrelated across the parent nodes 170a-d.

In some embodiments, the effective service factor dependency graph 172 defines or otherwise represents a fault propagation tree for effective service factor performance metric for control variable and/or manipulated variable. The effective service factor dependency graph 172 may include a CV low effective service factor parent node 172a and/or MV low effective service factor parent node 172b. Additionally, the effective service factor dependency graph may include one or more child nodes for each parent nodes 172a-b which may or may not be interrelated across the parent nodes 172a-b.

In some embodiments, the model quality dependency graph 174 defines or otherwise represents a fault propagation tree for model quality performance metric for control variables. The model quality dependency graph 174 may include a model quality issue parent node 174a and one or more child nodes.

In some embodiments, the oscillation index dependency graph 176 defines or otherwise represents a fault propagation tree for oscillation index performance metric for control variable and/or manipulated variable. The oscillation index performance dependency graph 176 may include a CV oscillation index parent node 176a and/or MV oscillation index parent node 176b. Additionally, the oscillation index dependency graph may include one or more child nodes for each parent nodes 176a-b which may or may not be interrelated across the parent nodes 176-b.

In this regard, in some embodiments, identifying low performance contributing assets includes, in response to determining that the PWO controller, APC controller, or other assets is associated with a low performance (e.g., calculated and/or predicted value below the corresponding threshold) or issue with respect to a performance metric, applying the performance data 306 to the one or more analytical models to identify low performing contributing assets with respect to the PWO controller, APC controller, or other assets.

For example, in some embodiments, in response to determining that the PWO controller, APC controller, and/or other assets is associated with a low performance service factor (e.g., service factor below the corresponding service factor threshold), the asset monitoring system 103 applies the performance data 306 to the one or more analytical models to identify low performance contributing assets with respect to the low service factor for the PWO controller, APC controller, and/or other assets

As another example, in some embodiments, in response to determining that a control variable and/or manipulated variable associated with a PWO controller and/or APC controller is associated with a low performance effective service factor (e.g., effective service factor below the corresponding effective service factor threshold), the asset monitoring system 103 applies the performance data 306 to the one or more analytical models to identify low performance contributing assets with respect to the low effective service factor for the control variable and/or manipulated variable.

As yet another example, in some embodiments, in response to determining that a control variable associated with a PWO controller and/or APC controller is associated with model quality issues (e.g., model quality below the corresponding model quality threshold), the asset monitoring system 103 applies the performance data 306 to the one or more analytical models to identify low performance contributing assets with respect to the model quality for the control variable.

As further example, in some embodiments, in response to determining that a control variable and/or manipulated variable associated with a PWO controller and/or APC controller is associated with a oscillation index issues (e.g., oscillation index performance below the corresponding oscillation threshold), the asset monitoring system 103 applies the performance data 306 to the one or more analytical models to identify low performance contributing assets with respect to the oscillation index for the control variable and/or manipulated variable. In some embodiments, the one or more analytical models is generated (e.g., by the asset monitoring system 103) by identifying asset performance dependency relationships between performance metrics for the PWO controller, one or more APC controllers, and/or other assets based on historical performance data (e.g., historical performance data) for a plurality of assets (e.g., PWO controller, APC controller, PID controller, and/or the like) and generating one or more asset performance dependency graphs (e.g., such as described above) based on the asset performance dependency relationships.

In some embodiments, the asset monitoring system 103 is configured to initiate performance of one or more plantwide optimization implementation actions based on the performance insight data 310. In some embodiments, initiating the performance of the one or more plantwide optimization implementation actions comprises causing rendering of an asset monitoring user interface comprising one or more representations of at least a portion of the performance insight data 310.

In some embodiments, initiating the performance of one or more plantwide optimization implementation actions comprises providing one or more corrective actions for improving the PWO controller performance. In some embodiments, the one or more corrective actions comprise one or more of recommended adjustment to one or more parameters (e.g., setpoints, and/or the like) of an APC controller, replacement of one or more components associated with an APC controller, and/or the like. In some embodiments, the one or more corrective actions comprise recommended adjustment to a PID controller connected to an APC controller.

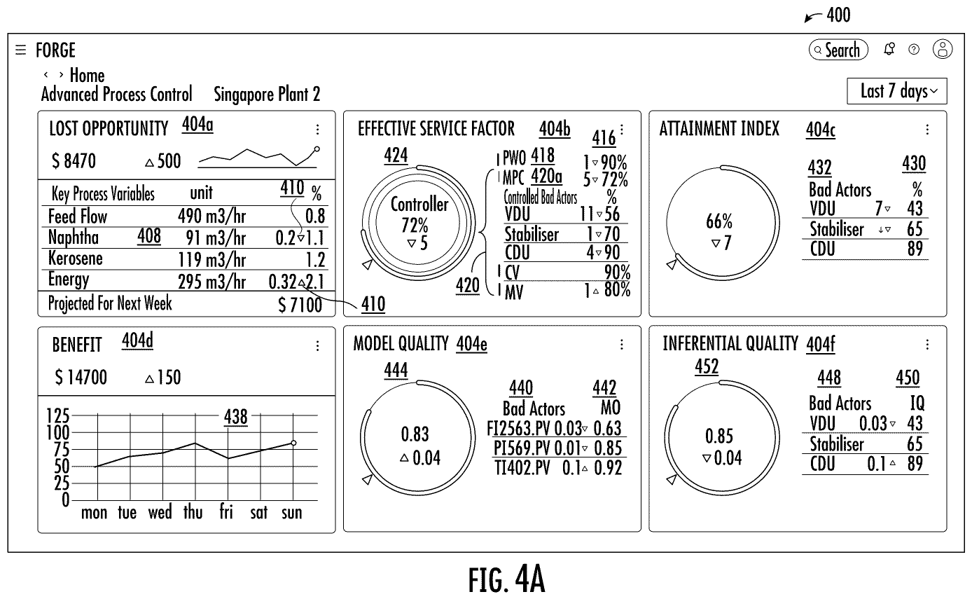

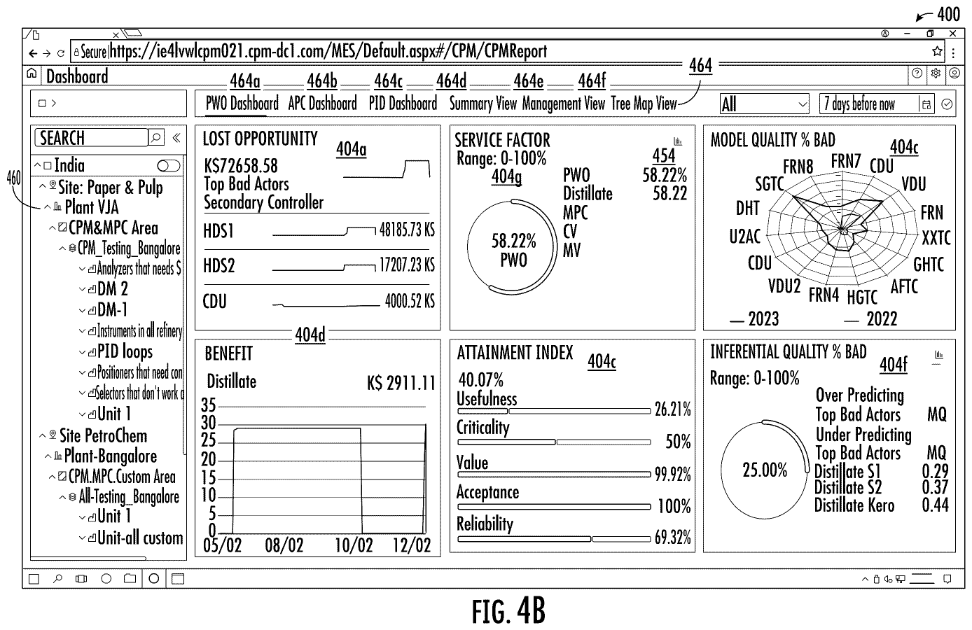

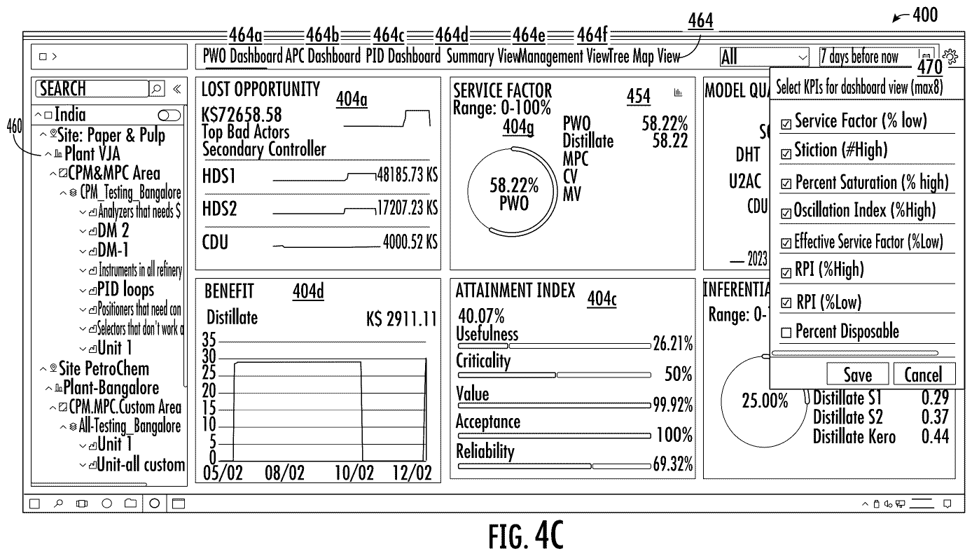

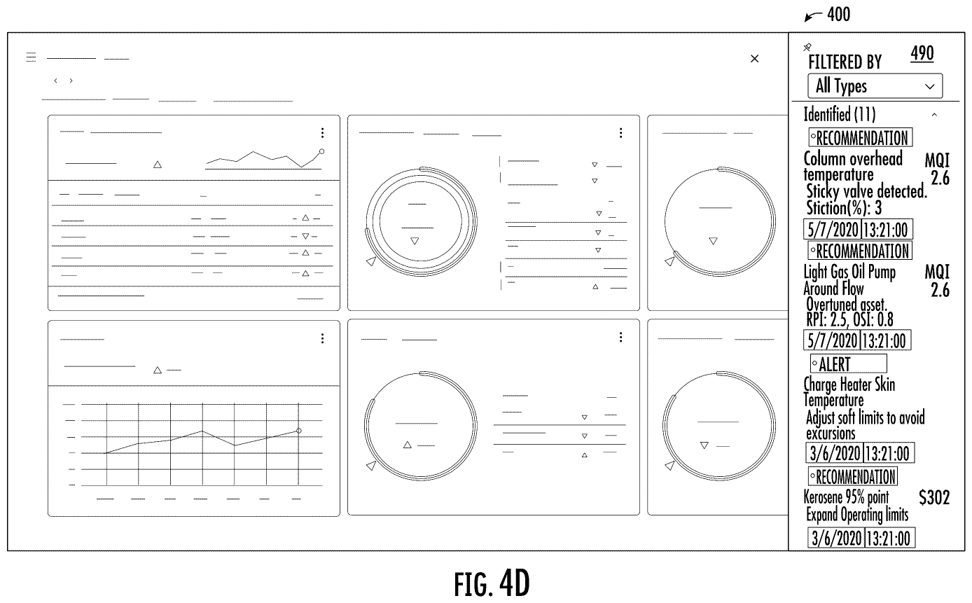

FIGS. 4A-4D illustrate example asset monitoring user interface 400 configured in accordance with at least one example embodiment of the present disclosure. The asset monitoring user interface 400 may be, for example, an electronic interface (e.g., a graphical user interface) of a client computing device or otherwise electronic interface configured for rendering on a client computing device (e.g., user device). The asset monitoring user interface may be configured for implementing plantwide asset visualization as described above. The asset monitoring user interface 400 may be configured for presenting or otherwise displaying a visualization of the plantwide performance insight data (e.g., at least a portion of the plantwide performance insight data) for a set of assets. In the illustrated example asset monitoring user interface 400, the asset monitoring user interface 400 may be configured to present the visualization of the plantwide performance insight data via one or more widgets (e.g., sub-interfaces) such as widgets 404a-n in the illustrated example. Each widget may be configured for presenting or otherwise displaying visualization of the plantwide performance insight data for the set of assets with respect to a particular performance metric. In some embodiments, the widgets 404a-n comprise lost opportunity widget 404a, effective service factor widget 404b, attainment index widget 404c, benefit 404d widget, model quality widget 404e, inferential quality widget 404f, service factor widget 404g, and/or other widgets.

The lost opportunity widget 404a may be configured for presenting and/or displaying a visualization of lost opportunity-related plantwide performance insight data. In some embodiments and as depicted in FIG. 4A, lost opportunity-related plantwide performance insight data may comprise one or more items of data representative and/or indicative of lost opportunity information with respect to one or more process variables 408 (e.g., key process variables) associated with the set of assets, such as feed flow, energy, and/or other process variables.

In some embodiments, the visualization of the lost opportunity-related plantwide performance insight data presented via the lost opportunity widget 404a includes one or more representations of the lost opportunity-related performance insight data for the set of assets. In some embodiments, the lost opportunity widget 404a may include one or more graphical representations such as a chart of lost opportunity information for the set of one or more assets

Alternatively or additionally, in some embodiments, the lost opportunity widget 404a includes textual representation of one or more process variables 408 (e.g., key process variables) along with calculated and/or predicted values for each process variable in one or more forms (e.g., unit measure, percentage measure). The one or more process variables 408, for example, may represent process variables that impact the lost opportunity metric over the time interval. As depicted in FIG. 4a, the lost opportunity widget 404a may include trend indicator(s) 410 representative and/or indicative of an amount of change of the process variables measures relative to past time interval.

The effective service factor (ESF) widget 404b may be configured for presenting and/or displaying a visualization of ESF-related plantwide performance insight data. In some embodiments and as depicted in FIG. 4A, ESF-related plantwide performance insight data may comprise one or more items of data representative and/or indicative of ESF information for the PWO controller or other assets and/or one or more assets identified as low performance contributing assets with respect to ESF for the PWO controller or other assets (e.g., top N assets identified as negatively impacting the ESF performance metric for the PWO controller or other assets).

In some embodiments, the visualization of the ESF-related plantwide performance insight data presented via the ESF widget 404b includes one or more representations of the ESF-related performance insight data for the set of assets. In some embodiments, the ESF widget 404b includes textual representation of one or more calculated and/or predicted ESF values 416 for the PWO controller 418 or other assets and the identified low performance contributing assets 420 with respect to ESF. As depicted in FIG. 4a, the ESF widget 404b may include trend indicator(s) representative and/or indicative of an amount of change of the ESF of the PWO controller 418 or other assets and/or the ESF of the one or more low performance contributing assets 420 relative to a past time interval.

Alternatively or additionally, in some embodiments, the ESF widget 404b may include one or more graphical representations such as a ESF graphical representation 424 for an MPC 420a associated with the PWO identified as a low performance contributing asset for the PWO 418 with respect to ESF.

The attainment index widget 404c may be configured for presenting and/or displaying a visualization of attainment index-related plantwide performance insight data. In some embodiments, attainment index-related plantwide performance insight data may comprise one or more items of data representative and/or indicative of attainment index information for the PWO controller 418 or other assets and/or one or more assets identified as low performance contributing assets 432 with respect to the attainment index for the PWO controller or other assets (e.g., top M assets identified as negatively impacting the attainment index performance metric for the PWO controller or other assets).

In some embodiments, the visualization of the attainment index-related plantwide performance insight data presented via the attainment index widget 404c includes one or more representations of the attainment index-related performance insight data for the set of assets. In some embodiments, the attainment index widget 404c includes textual representation of one or more calculated and/or predicted attainment index values 430 for the PWO controller 418 or other assets and the identified low performance contributing assets 432. Alternatively or additionally, in some embodiments, the attainment index widget 404c may include one or more graphical representations such as an attainment index graphical representation 424 for an MPC 420a associated with the PWO identified as a low performance contributing asset for the PWO controller 418 or other assets with respect to attainment index.

The benefit widget 404d may be configured for presenting and/or displaying a visualization of benefit-related plantwide performance insight data. In some embodiments, benefit-related plantwide performance insight data may comprise one or more items of data representative and/or indicative of benefit information associated with the set of assets.

In some embodiments, the visualization of the benefit-related plantwide performance insight data presented via the benefit widget 404d includes one or more representations of the attainment index-related performance insight data for the set of assets. In some embodiments, the benefit widget 404d includes a graphical representations such as a benefit chart 438.

The model quality widget 404e may be configured for presenting and/or displaying a visualization of model quality-related plantwide performance insight data. In some embodiments, model quality-related plantwide performance insight data may comprise one or more items of data representative and/or indicative of model quality information for the PWO controller 418 or other assets and/or one or more assets identified as low performance contributing assets 440 with respect to the model quality performance for the PWO controller or other assets (e.g., top P assets identified as negatively impacting the model quality performance metric for the PWO controller 418 or other assets).

In some embodiments, the visualization of the model quality-related plantwide performance insight data presented via the model quality widget 404e includes one or more representations of the model quality-related performance insight data for the set of assets. In some embodiments, the model quality widget 404e includes textual representation of one or more calculated and/or predicted model quality values 442 for the PWO controller 418 or other assets and/or the identified low performance contributing assets 442. Alternatively or additionally, in some embodiments, the model quality widget 404e may include one or more graphical representations such as a model quality graphical representation 444.

The inferential quality widget 404f may be configured for presenting and/or displaying a visualization of inferential quality-related plantwide performance insight data. In some embodiments, inferential quality-related plantwide performance insight data may comprise one or more items of data representative and/or indicative of inferential quality information for the PWO controller 418 or other assets and/or one or more assets identified as low performance contributing assets 448 with respect to the model quality performance for the PWO controller or other assets (e.g., top L assets identified as negatively impacting the inferential quality performance metric for the PWO controller 418 or other assets).

In some embodiments, the visualization of the inferential quality-related plantwide performance insight data presented via the inferential quality widget 404f includes one or more representations of the inferential quality-related performance insight data for the set of assets. In some embodiments, the inferential quality widget 404f includes textual representation of one or more calculated and/or predicted model quality values 450 for the PWO controller 418 or other assets and/or the identified low performance contributing assets 448. Alternatively or additionally, in some embodiments, the inferential quality widget 404f may include one or more graphical representations such as an inferential quality graphical representation 452.

The service factor (SF) widget 404g may be configured for presenting and/or displaying a visualization of SF-related plantwide performance insight data. In some embodiments and as depicted in FIG. 4b, SF-related plantwide performance insight data may comprise one or more items of data representative and/or indicative of SF information for the PWO controller or other assets and/or one or more assets identified as low performance contributing assets with respect to SF for the PWO controller or other assets (e.g., top N assets identified as negatively impacting the ESF performance metric for the PWO controller).

In some embodiments, the visualization of the SF-related plantwide performance insight data presented via the SF widget 404g includes one or more representations of the SF-related performance insight data for the set of assets. In some embodiments, the SF widget 404g includes textual representation of one or more calculated and/or predicted SF values 454 for the PWO controller 418 or other assets and the identified low performance contributing assets 420 with respect to SF. Alternatively or additionally, in some embodiments, the SF widget 404g may include one or more graphical representations such as a SF graphical representation 424 for the PWO controller 418 or other assets identified as a low performance contributing asset for the PWO controller 418 or other assets with respect to ESF.

As shown, in FIG. 4B, the asset monitoring using interface 400 may include a location selection menu bar 460. In the illustrated example asset monitoring user interface 400, the location selection menu bar 460 is located at a side portion of the asset monitoring user interface 400 and vertically orientated. However, it would be appreciated that the location selection menu bar 460 may be positioned somewhere else within the asset monitoring user interface 400 and may be positioned in other orientations (e.g., horizontal, diagonal, stacked, and/or the like).

The location selection menu bar 460 may be configured to facilitate selection of and rendering of a site, plant, area, unit, and/or other level associated with an enterprise to, for example, view and/or interact with the performance insight data associated therewith. For example, the location selection menu bar 460 may include one or more location interface elements selectable from the location selection menu bar 460, each representing a particular site, particular, plant, particular unit, and/or other levels associated with an enterprise.

The asset monitoring user interface 400 may include a dashboard menu bar 464. In the illustrated example asset monitoring user interface 400, the dashboard menu bar 464 is located at a top portion of the asset monitoring user interface 400 and horizontally orientated. However, it would be appreciated that the dashboard menu bar 464 may be positioned somewhere else within the asset monitoring user interface 400 and may be positioned in other orientations (e.g., vertical, diagonal, stacked, and/or the like).

The dashboard menu bar 464 may be configured to facilitate selection of and rendering of one or more dashboards and/or views. The dashboard menu bar 464 may include one or more dashboard interface elements selectable from a dashboard menu bar 464. Each of the dashboard interface elements may be configured to render a particular dashboard or otherwise interface view comprising representation(s) of at least a portion of the plantwide performance insight data. As depicted in FIG. 4B, the dashboard menu bar 464 includes a PWO dashboard interface element 464a, APC dashboard interface element 464b, PID dashboard interface element 464c, summary view interface element 464d, management view interface element 464e, and tree map view interface element 464f. It would be appreciated that the dashboard menu bar 464 may include other dashboard interface elements and/or may not include one of the dashboard interface elements 464a-f.

The PWO dashboard interface element 464a may be configured to facilitate selection and rendering of PWO performance insight visualizations via one or more widgets such as widgets 404a-n. For example, the asset monitoring user interface 400 may configured to display at least a portion of the one or more of the widgets 404a-n, wherein each widget comprises visualization of performance insight data for the PWO and/or other assets with respect to a particular performance metric. The asset monitoring user interface 400 may include a widget selection interface element 470 configured to facilitate selection of a portion of the one or more widgets 404a-n to display. As shown in FIG. 4D, in some embodiments, user interface 400 may be configured to display recommendations 490 for resolving a fault.

In some embodiments, the asset monitoring user interface is configured for being displayed on a client computing device. In some embodiments, the asset monitoring user interface comprises one or more asset dashboard visualization data is rendered on the client computing device via the asset monitoring user interface.

In some embodiments, the performance visualization rendered via the asset monitoring user interface presents a visualization of one or more portions of the performance data for the set of assets to facilitate analysis and/or management of the set of assets via the asset performance visualization. In some embodiments, the asset performance visualization rendered via the asset monitoring user interface presents performance insight data for the set of assets. In some embodiments, the asset monitoring user interface is displayed in response to interaction with respect to an interactive display element associated with the asset data presented via the asset monitoring user interface. In some embodiments, the asset monitoring user interface presents asset detail data configured to present metrics, contextual data, and/or configuration data for an asset associated with the set of assets. Alternatively or additionally, in some embodiments, the asset monitoring user interface presents remote control data configured to facilitate remote control of an asset. In some embodiments, the remote control data includes one or more interactive display elements that facilitate modification.

### Example Processes of the Disclosure

Having described example systems and apparatuses, data visualizations, and user interfaces in accordance with the disclosure, example processes of the disclosure will now be discussed. It will be appreciated that each of the flowcharts depicts an example computer-implemented process that is performable by one or more of the apparatuses, systems, devices, and/or computer program products described herein, for example utilizing one or more of the specially configured components thereof.

Although the example processes depicts a particular sequence of operations, the sequence may be altered without departing from the scope of the present disclosure. For example, some of the operations depicted may be performed in parallel or in a different sequence that does not materially affect the function of the processes.

The blocks indicate operations of each process. Such operations may be performed in any of a number of ways, including, without limitation, in the order and manner as depicted and described herein. In some embodiments, one or more blocks of any of the processes described herein occur in-between one or more blocks of another process, before one or more blocks of another process, in parallel with one or more blocks of another process, and/or as a sub-process of a second process. Additionally or alternatively, any of the processes in various embodiments include some or all operational steps described and/or depicted, including one or more optional blocks in some embodiments. With regard to the flowcharts illustrated herein, one or more of the depicted block(s) in some embodiments is/are optional in some, or all, embodiments of the disclosure. Optional blocks are depicted with broken (or “dashed”) lines. Similarly, it should be appreciated that one or more of the operations of each flowchart may be combinable, replaceable, and/or otherwise altered as described herein.

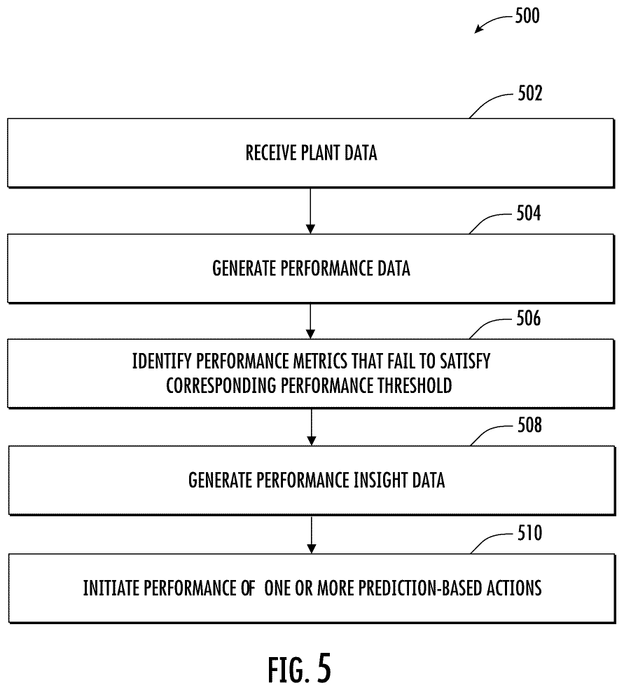

FIG. 5 illustrates a flowchart including operations of an example process/method for improved asset monitoring and performance visualization in accordance with at least one example embodiment of the present disclosure. In some embodiments, the process/method 500 is embodied by computer program code stored on a non-transitory computer-readable storage medium of a computer program product configured for execution to perform the process as depicted and described. Alternatively or additionally, in some embodiments, the process/method 500 is performed by one or more specially configured computing devices, such as the apparatus 200 alone or in communication with one or more other component(s), device(s), system(s), and/or the like. In this regard, in some such embodiments, the apparatus 200 is specially configured by computer-coded instructions (e.g., computer program instructions) stored thereon, for example in the memory 204 and/or another component depicted and/or described herein and/or otherwise accessible to the apparatus 200, for performing the operations as depicted and described. In some embodiments, the apparatus 200 is in communication with one or more external apparatus(es), system(s), device(s), and/or the like, to perform one or more of the operations as depicted and described. For example, the apparatus 200 in some embodiments is in communication with separate component(s) of a network, external network(s), and/or the like, to perform one or more of the operation(s) as depicted and described. For purposes of simplifying the description, the process/method 500 is described as performed by and from the perspective of the apparatus 200.

Although the example process/method 500 depicts a particular sequence of operations, the sequence may be altered without departing from the scope of the present disclosure. For example, some of the operations depicted may be performed in parallel or in a different sequence that does not materially affect the function of the process/method 500. In other examples, different components of an example device or system that implements the process/method 500 may perform functions at substantially the same time or in a specific sequence.

According to some examples, the process/method 500 includes at operation 502, receiving plant data associated with an industrial plant. For example, the apparatus 200 may receive plant data associated with an industrial plant. The apparatus 200 may receive the plant data from a process control and automation system 104 associated with the industrial plant.

In some embodiments, at least a portion of the plant data comprise PWO data for a PWO controller associated with the industrial plant. Additionally, in some embodiments, at least a portion of the plant data comprise APC data for one or more APC controllers associated with the PWO controller. In various embodiments, the PWO controller and one or more APC controllers represent components of, or otherwise associated with, a process control and automation system 104 associated with the industrial plant. In some embodiments, the plant data comprises other asset data such as control variable (CV) data, manipulated (MV) data, and/or disturbance (DV) variable. In some embodiments, the CV data, MV data, and/or DV data may be included in the PWO data and/or the APC data.

According to some examples, the process/method 500 includes at operation 504, generating performance data based on the plant data. For example, the apparatus 200 may generate performance data by performing analytics on the performance data. The performance data may comprise PWO performance data for the PWO controller and/or APC performance data for the one or more APC controllers. In various embodiments, the PWO performance data comprises one or more items of data representative and/or descriptive of the performance of the PWO with respect to one or more performance metrics for the PWO. For example, the PWO performance data 306a may comprise calculated and/or predicted values for one or more KPIs for the PWO controller and/or one or more variables (e.g., CV, MV, and/or DV) associated with the PWO controller.

In some embodiments, the APC performance data comprises one or more items of data representative and/or descriptive of the performance of at least one APC controller with respect to one or more performance metrics for the APC. For example, the APC performance data may comprise calculated and/or predicted values for one or more KPIs for at least one APC controller and/or one or more variables (e.g., CV, MV, and/or DV) associated with the respective APC controller.

Non-limiting examples of KPIs for assets such as PWO controllers and APC controllers and associated variables include service factor (SF), model quality index (MQI), inferential quality index (IQI), RPI, stiction, percent saturation, oscillation index, effective service factor (ESF), lost opportunity, benefit, and/or the like.

In some embodiments, generating the performance data comprises calculating the PWO performance data and APC data based on relevant portions of the plant data. For example, in some embodiments, the apparatus 200 is configured to generate the PWO performance data by calculating one or more performance metric values (e.g., KPI values) for the PWO using the PWO data and generate the APC performance data for one or more APC controllers by calculating the performance metric values (e.g., KPI values) for the respective APC controller using the APC data. For example, the PWO performance data may comprise one or more performance metric values for the PWO controller and the APC performance data 306b may comprise performance metric values for one or more APC controllers associated with the PWO controller. Alternatively or additionally, the performance data may comprise CV performance data, MV performance data, and/or DV performance data for CVs, MVs, and/or DVs associated with PWO controller and/or one or more APC controllers.

In some embodiments, the apparatus 200 is configured to generate the performance data using one or more specially-configured algorithms. For example, the apparatus 200 may apply the plant data to the one or more performance analysis machine learning models configured to receive the plant data and perform a predictive performance analysis operation on the plant data to generate the performance data.

In some embodiments, applying the plant data to the one or more performance analysis machine learning models comprises the apparatus 200 inputting the plant data or portion thereof (e.g., PWO data or APC data) into the one or more performance analysis machine learning models and obtaining the performance data output by the performance analysis machine learning model, wherein the performance data output by the performance analysis machine learning model comprises the PWO performance data 306a and/or the APC performance data 306b.

According to some examples, the process/method 500 includes at operation 506, identifying performance metrics that fail to satisfy corresponding performance threshold based on the performance data. In various embodiments, identifying performance metrics that fail to satisfy corresponding performance metrics includes identifying performance metrics for the PWO controller, APC controller, and/or other assets of the set of assets associated with the process control and automation system 104. For example, the apparatus 200 may identify performance metrics for the PWO controller that fail to satisfy the corresponding performance threshold for the performance metric by analyzing the performance data for the PWO controller. In various embodiments, a PWO controller identified as having a performance metric that fails to satisfy the corresponding performance threshold may be referred to as a poorly performing PWO at least with respect to the particular performance metric that fails to satisfy the corresponding performance threshold.

Alternatively or additionally, in various embodiments, the apparatus 200 identifies performance metrics for the APC controller(s) that fail to satisfy the corresponding performance threshold for the performance metric by analyzing the performance data for the APC controller(s). In various embodiments, an APC controller identified as having a performance metric that fails to satisfy the corresponding performance threshold may be referred to as a poorly performing APC at least with respect to the particular performance metric that fails to satisfy the corresponding performance threshold.

According to some examples, the process/method 500 includes at operation 508, generating performance insight data (e.g., asset performance insight data). For example, the apparatus 200 may generate performance insight data in response to identify performance metrics that fail to satisfy corresponding performance threshold. In some embodiments, generating the performance insight data includes identifying one or more assets of the sets of assets associated with the process control and automation system 104 impacting the performance of the PWO controller with respect to an identified performance metric for the PWO that fails to satisfy the corresponding performance threshold.

Alternatively or additionally, in some embodiments, generating the performance insight data includes identifying one or more assets of the sets of assets associated with the process control and automation system 104 impacting the performance of an APC controller with respect to an identified performance metric for the APC controller that fails to satisfy the corresponding performance threshold. In this regard, in some embodiments, the performance insight data includes one or more items of data representative and/or indicative of a subset of asset of the set of assets associated with the process control and automation system 104 that affect the performance metrics of a PWO controller, APC controller, and/or other assets.

In some embodiments, the apparatus 200 leverages one or analytical models to identify low performance contributing assets in response to determining that an asset such a PWO controller, APC controller, and/or or other assets fail to satisfy the corresponding threshold. For example, in response to determining that a particular performance metric for a PWO controller fails to satisfy the corresponding threshold, the asset monitoring system 103 identifies low performance contributing assets with respect to the particular performance metric for the PWO controller. In some embodiments, identifying low performance contributing assets with respect to the performance metric for the PWO includes identifying the top N poor performing assets associated with the PWO controller.

As another example, in response to determining that a performance metric for an APC controller fails to satisfy the corresponding threshold, the apparatus 200 identifies low performance contributing assets with respect to the performance metric for the APC controller. In some embodiments, identifying low performance contributing assets with respect to a performance metric for the APC includes identifying the top N poor performing assets associated with the PWO controller.

As yet another example, in response to determining that a performance metric for a variable (e.g., CV, MV, DV, or the like) fails to satisfy the corresponding threshold, the apparatus 200 identifies low performance contributing assets with respect to the performance metric for the variable. In some embodiments, identifying low performance contributing assets with respect to a performance metric for the variable includes identifying the top N poor performing assets associated with the variable with respect to the performance metric. In some embodiments, a poor performing asset may describe an asset that is associated with a performance metric below a corresponding threshold. As described above, in some embodiments, N is an integer (e.g., 1, 4, 7, or the like) and may be the same or different for the various assets and/or performance metrics. In some embodiments, the one or more analytical models may comprise a ranking model and/or algorithm such that the one or more analytical models may be configured to rank identified poor performing assets and select the top N poor performing assets.

In some embodiments, the apparatus is configured to apply the performance data to one or more analytical models (e.g., at least one of the one or more analytical models) configured to perform predictive data analysis task on the performance data to generate performance insight data comprising data. In some embodiments, the performance insight data includes one or more items of data representative and/or indicative of low performance contributing assets with respect to the PWO controller, APC controller(s), and/or other assets associated with the process control and monitoring system.

In some embodiments, applying the performance data to one or more analytical models comprises inputting, by the apparatus 200, performance data to the one or more analytical models and obtaining the performance insight data output by the one or more analytical models. In some embodiments, the one or more analytical models define or otherwise comprise one or more asset performance dependency graphs that are leveraged by the one or more analytical models to generate performance insight data. In this regard, in some embodiments, the one or more analytical models may be configured to perform predictive data analysis task on the performance data using the one or more service performance dependency graphs (or portion thereof). In some embodiments, performing predictive data analysis task on the performance data 306 includes traversing the one or more performance dependency graphs (or portion thereof) to identify assets associated with the PWO controller, an APC controller, CV, MV, DV, and/or other assets contributing to the low performance of the respective asset by analyzing the performance data and using the asset performance dependency graphs.

In some embodiments, an asset performance dependency graph is a graphical representation of dependency relationships between and/or among assets with respect to each of one or more performance metrics. The asset performance dependency graph, for example, may represent a fault propagation tree (e.g., root cause propagation tree) associated with a set of assets associated with the process control and automation system 104. In some embodiments, the asset performance dependency graph may take the form of a spider web view.

In some embodiments, generating the performance insight data comprises generating one or more recommendations for improving identified performance metrics for the PWO controller and/or APC controller that fail to satisfy the corresponding threshold based on the identified low performance contributing assets. In this regard, in some embodiments, the performance insight data includes one or more items of data representative and/or indicative of one or more recommendations for improving identified performance metrics that fail to satisfy the corresponding threshold.

In some embodiments, the one or more recommendations may include recommendations to identify faults associated with low performance contributing assets. In some embodiments, the one or more recommendations may include proposed solutions for resolving the predicted faults associated with low performance contributing assets. For example, in some embodiments, the apparatus 200 may be configured to identify faults associated with low performance contributing assets and identify solutions for resolving the faults.

According to some examples, the process/method 500 includes at operation 510, initiating performance of one or more plantwide optimization implementation actions based on the performance insight data. For example, the apparatus 200 may initiate performance of one or more plantwide optimization implementation actions based on the performance insight data. In some embodiments, initiating the performance of the one or more plantwide optimization implementation actions comprises causing rendering of an asset monitoring user interface comprising one or more representations of at least a portion of the performance insight data on a display of one or more client computing entities. The apparatus 200 may transmit computer-executable instructions configured to cause an asset monitoring user interface to be rendered on a display of one or more client computing entities, wherein the asset monitoring user interface comprises representations of at least a portion of the performance insight data. For example, the apparatus 200 may transmit the computer-executable instructions to the one or more client computing entities or other computing entities, which may or may not be associated with the apparatus 200.

In some embodiments, initiating the performance of one or more plantwide optimization implementation actions comprises providing one or more corrective actions (e.g., recommendations) for improving the PWO controller performance. In some embodiments, the one or more corrective actions comprise one or more of recommended adjustment to one or more parameters (e.g., setpoints, and/or the like) of an APC controller, replacement of one or more components associated with an APC controller, and/or the like. In some embodiments, the one or more corrective actions comprise recommended adjustment to a PID controller connected to an APC controller.

In some embodiments, initiating the performance of one or more plantwide optimization implementation actions comprises generating and providing one or more alerts, notifications, warnings, alarms, and/or the like. In some embodiments, initiating the performance of one or more plantwide optimization implementation actions comprises automatically modifying the configuration of one or more assets and or equipment associated with the one or more assets. The apparatus 200 may be configured to transmit computer-executable instructions to the process control and automation system 104 and/or other computing entities or systems associated with the plant, wherein the computer-executable instructions is configured to cause the configuration of one or more assets and or equipment associated with the one or more assets to be automatically modified. In some embodiments, initiating the performance of one or more plantwide optimization implementation actions comprises automatically adjusting one or more parameters (e.g., setpoint for one or more operating parameters or the like) associated with a low performance contribution asset. The apparatus 200 may be configured to transmit computer-executable instructions to the process control and automation system 104 and/or other computing entities or systems associated with the plant, wherein the computer-executable instructions is configured to cause one or more parameters (e.g., setpoint for one or more operating parameters or the like) associated with a low performance contributing asset to be automatically adjusted. In some embodiments, initiating the performance of one or more plantwide optimization implementation actions comprises automatically adjusting one or more parameters (e.g., setpoint for one or more operating parameters or the like) associated with the one or more processing units associated with the PWO controller, wherein the one or more processing units comprise one or more equipment. The apparatus 200 may be configured to transmit computer-executable instructions to the process control and automation system 104 and/or other computing entities or systems associated with the plant, wherein the computer-executable instructions is configured to cause one or more parameters (e.g., setpoint for one or more operating parameters or the like) associated with one or more processing units associated with the PWO controller to be automatically adjusted.

### Conclusion

Although an example processing system has been described above, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a repository management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client computer having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
generating, by one or more processors, performance data for a set of assets by performing analytics on plant data associated with the set of assets, wherein the set of assets include at least a plantwide optimizer (PWO) controller and one or more advanced process control (APC) controllers associated with the PWO controller;
identifying, by the one or more processors, a first performance metric for the PWO controller that fails to satisfy a first performance threshold by comparing the performance data to one or more PWO performance thresholds;
generating, by the one or more processors, performance insight data in response to identifying the first performance metric at least in part by applying the performance data to one or more analytical models comprising one or more asset performance dependency graphs; and
initiating, by the one or more processors, performance of one or more plantwide optimization implementation actions based on the performance insight data.

2. The computer-implemented method of claim 1, further comprising:
receiving the plant data from an industrial plant, wherein the plant data comprises PWO data for the PWO controller and APC data for the one or more APC controllers, and wherein the plant data is generated via a process control and monitoring system associated with the industrial plant.

3. The computer-implemented method of claim 1, further comprising:
generating the one or more analytical models by:
identifying asset performance dependency relationships between performance metrics for the PWO controller and the one or more APC controllers based on historical asset performance data; and
generating the one or more asset performance dependency graphs based on the asset performance dependency relationships.

4. The computer-implemented method of claim 1, wherein the performance insight data comprises one or more items of data representing low performance contributing assets from the set of assets impacting the first performance metric for the PWO controller.

5. The computer-implemented method of claim 4, wherein the one or more analytical models is configured to perform predictive data analysis task on the performance data to identify the low performance contributing assets at least in part by traversing a first performance dependency graph corresponding to the first performance metric.

6. The computer-implemented method of claim 1, further comprising:
identifying a second performance metric for an APC controller of the one or more APC controllers that fails to satisfy a second performance threshold by comparing the performance data to one or more APC performance thresholds; and
in response to identifying the second performance metric, applying the performance data to the one or more analytical models configured to perform predictive data analysis task on the performance data using the one or more asset performance dependency graphs.

7. The computer-implemented method of claim 1, further comprising:
determining one or more corrective actions for improving the first performance metric based on the performance insight data.

8. The computer-implemented method of claim 1, wherein initiating the performance of one or more plantwide optimization implementation actions comprises:
causing rendering of an asset monitoring user interface comprising one or more representations of the performance insight data.

9. The computer-implemented method of claim 1, wherein initiating performance of one or more plantwide optimization implementation actions comprises automatically adjusting one or more parameters associated with a low performance contribution asset.

10. The computer-implemented method of claim 1, wherein the PWO controller is associated with one or more processing units and initiating the performance of one or more plantwide optimization implementation actions comprises automatically adjusting one or more parameters associated with the one or more processing units, wherein the one or more processing units comprise one or more equipment.

11. An apparatus comprising at least one processor and at least one memory storing instructions that, when executed by the at least one processor, cause the apparatus to:
generate performance data for a set of assets by performing analytics on plant data associated with the set of assets, wherein the set of assets include at least a plantwide optimizer (PWO) controller and one or more advanced process control (APC) controllers associated with the PWO controller;
identify a first performance metric for the PWO controller that fails to satisfy a first performance threshold by comparing the performance data to one or more PWO performance thresholds;
generate performance insight data in response to identifying the first performance metric at least in part by applying the performance data to one or more analytical models comprising one or more asset performance dependency graphs; and
initiating performance of one or more plantwide optimization implementation actions based on the performance insight data.

12. The apparatus of claim 11, further comprising:
receiving the plant data from an industrial plant, wherein the plant data comprises PWO data for the PWO controller and APC data for the one or more APC controllers, and wherein the plant data is generated via a process control and monitoring system associated with the industrial plant.

13. The apparatus of claim 11, wherein the apparatus is further caused to generate the one or more analytical models by:
identifying asset performance dependency relationships between performance metrics for the PWO controller and the one or more APC controllers based on historical asset performance data; and
generating the one or more asset performance dependency graphs based on the asset performance dependency relationships.

14. The apparatus of claim 11, wherein the performance insight data comprises one or more items of data representing low performance contributing assets from the set of assets impacting the first performance metric for the PWO controller.

15. The apparatus of claim 14, wherein the one or more analytical models is configured to perform predictive data analysis task on the performance data to identify the low performance contributing assets at least in part by traversing a first performance dependency graph corresponding to the first performance metric.

16. The apparatus of claim 11, wherein the apparatus is further caused to:
identify a second performance metric for an APC controller of the one or more APC controllers that fails to satisfy a second performance threshold by comparing the performance data to one or more APC performance thresholds; and
in response to identifying the second performance metric, applying the performance data to the one or more analytical models configured to perform predictive data analysis task on the performance data using the one or more asset performance dependency graphs.

17. The apparatus of claim 11, wherein the apparatus is further caused to:
determine one or more corrective actions for improving the first performance metric based on the performance insight data.

18. The apparatus of claim 11, wherein initiating the performance of one or more plantwide optimization implementation actions comprises:
causing rendering of an asset monitoring user interface comprising one or more representations of the performance insight data.

19. The apparatus of claim 11, wherein initiating the performance of one or more plantwide optimization implementation actions comprises automatically adjusting one or more parameters associated with a low performance contribution asset.

20. At least one non-transitory computer-readable storage medium having computer coded instructions configured to, when executed by at least one processor:
generate performance data for a set of assets by performing analytics on plant data associated with the set of assets, wherein the set of assets include at least a plantwide optimizer (PWO) controller and one or more advanced process control (APC) controllers associated with the PWO controller;
identify a first performance metric for the PWO controller that fails to satisfy a first performance threshold by comparing the performance data to one or more PWO performance thresholds;
generate performance insight data in response to identifying the first performance metric at least in part by applying the performance data to one or more analytical models comprising one or more asset performance dependency graphs; and
initiate performance of one or more plantwide optimization implementation actions based on the performance insight data.
